(19) United States
(12) Patent Application Publication
(10) Pub. No.: US 2010/0203387 A1
(43) Pub. Date: Aug. 12, 2010

(54) ELECTRODE FOR LITHIUM RECHARGEABLE BATTERY AND LITHIUM RECHARGEABLE BATTERY COMPRISING THE ELECTRODE

(76) Inventors: Taisuke Yamamoto, Nara (JP); Shuji Ito, Nara (JP); Masaya Ugaji, Osaka (JP); Katsumi Kashiwagi, Osaka (JP)

Correspondence Address: MCDERMOTT WILL & EMERY LLP, 600 13TH STREET, NW, WASHINGTON, DC, 20005-3096, US

(21) Appl. No.: 12/672,856

(22) PCT Filed: Aug. 6, 2008
(86) PCT No.: PCT/JP2008/002130

§ 371 Date: Feb. 9, 2010

(30) Foreign Application Priority Data
Aug. 9, 2007 (JP) 2007-207890
Mar. 5, 2008 (JP) 2008-055008

(51) Int. Cl. H01M 4/58; H01M 4/02

(52) U.S. Cl. 429/220; 429/231.95

(57) ABSTRACT

An electrode for a lithium secondary battery 100 includes a current collector 11 having a plurality of bumps 12 on a surface thereof and an active material layer 15 including an active material member 14 formed on each of the plurality of bumps 12. The plurality of bumps 12 are regularly arrayed at an interval from one another on the surface of the current collector 11; a growth direction S of the active material members 14 is tilted with respect to the normal direction D of the current collector 11; voids 16 are formed between adjoining active material members 14; a proportion which the voids 16 account for in the active material layer 14 along any arbitrary direction is 5% or more on a plane which is parallel to the surface of the current collector 11; and tensile strength of the current collector 11 per 1 μm of height of the active material members 14 is no less than 0.3 N/mm and no more than 1 N/mm.

### TECHNICAL FIELD

The present invention relates to an electrode for a lithium secondary battery and a lithium secondary battery having the same.

### BACKGROUND ART

In recent years, with the development of portable devices such as personal computers and mobile phones, there is an increasing need for batteries as their power supplies. Batteries to be used for such purposes are required to have a high energy density. Against such requirements, lithium secondary batteries are drawing attention, and active materials which have a higher capacity than conventionally are being developed for either their positive electrodes or their negative electrodes. Among others, an elemental, oxide, or alloy form of silicon (Si) or tin (Sn) is regarded as a promising active material which can provide a very large capacity.

However, when an electrode for a lithium secondary battery is constructed by using such active materials, there is a problem in that the electrode will be deformed through repetitive charging and discharging. The aforementioned active materials undergo significant volumetric changes when reacting with lithium ions. Therefore, at the time of charging and discharging, the active material will undergo significant expansion/contraction due to reactions of insertion and desorption of lithium ions with respect to the active material. Therefore, when charging and discharging are repeated, a large stress will occur in the electrode to cause strain, thus resulting in wrinkles, breaks, and the like. Moreover, when the electrode is strained and deformed, a space may be created between the electrode and the separator, so that the charging and discharging reaction may become nonuniform, thus locally deteriorating the battery characteristics. Against this, a proposal of increasing the tensile strength of the current collector has been made (Patent Document 1). However, it is difficult to sufficiently suppress deformation of the electrode while ensuring a high capacity, thus making it difficult to obtain a lithium secondary battery having sufficient charge-discharge cycle characteristics.

In order to solve these problems, Patent Document 2 and Patent Document 3 propose a negative electrode in which a plurality of pillar-like members made of an active material are arrayed on a current collector. Such pillar-like members are created by forming a film of active material on the current collector, and patterning it by photolithography. Alternatively, they are formed by selectively depositing the active material on the current collector with plating technique. In accordance with this construction, the pillar-like members will expand so as to fill the voids between themselves, whereby deteriorations in the electrode characteristics due to expansion stress can be suppressed. However, the need to perform a patterning step when forming the pillar-like members presents a difficulty in application to mass production processes.

On the other hand, Patent Document 4 and Patent Document 5 of the Applicants propose, on the current collector surface, forming pillar-like active material members each having a major axis which is tilted with respect to the normal direction of the current collector surface. In accordance with this construction, spaces for alleviating expansion stress of silicon are obtained between active material members, so that deformation of the negative electrode can be suppressed, and deteriorations in cycle characteristics can be suppressed. Such active material members are obtained by, in an ambient containing oxygen, vapor-depositing silicon particles on a current collector whose surface has been subjected to a roughening treatment, from a direction that is tilted with respect to the normal direction of the current collector (oblique vapor deposition). At this time, since silicon particles will not be vapor-deposited in any portion that is shaded by the silicon oxide having grown on the current collector (shadowing effect), it is possible to grow silicon oxide while providing interspaces on the current collector surface for absorbing the volumetric expansion. Thus, in the methods of forming a negative electrode proposed in Patent Document 4 and Patent Document 5, active material members are formed by performing oblique vapor deposition to utilize a shadowing effect, and therefore there is no need to perform a patterning step as described in Patent Document 2 or Patent Document 3.

[Patent Document 1] pamphlet of International Publication No. 2001/031723

[Patent Document 2] Japanese Laid-Open Patent Publication No. 2004-127561

[Patent Document 3] Japanese Laid-Open Patent Publication No. 2003-303586

[Patent Document 4] pamphlet of International Publication No. 2007/015419

[Patent Document 5] pamphlet of International Publication No. 2007/052803

### DISCLOSURE OF INVENTION

### Problems to be Solved by the Invention

In the methods of forming active material members proposed in Patent Document 4 and Patent Document 5, depending on the surface roughness of the current collector surface or the evaporation angle, it may not be possible to obtain sufficient voids between adjoining active material members. Therefore, contact between active material members is likely to occur, so that a significant stress may emerge in the current collector upon expansion of the active material members at charging, thus deforming the electrode. As a result, deteriorations in the charge-discharge cycle characteristics and reliability of the lithium secondary battery may occur.

The present invention has been made in order to solve the aforementioned problems, and an objective thereof is to, in an electrode for a lithium secondary battery having a plurality of active material members on a current collector, reduce the stress acting on the current collector due to expansion and contraction of the active material members, thus providing improved charge-discharge cycle characteristics and reliability.

### Means for Solving the Problems

An electrode for a lithium secondary battery according to the present invention includes a current collector having a plurality of bumps on a surface thereof and an active material layer having an active material member formed on each of the plurality of bumps. The plurality of bumps are regularly arrayed at an interval from one another on the surface of the current collector. The growth direction of the active material members is tilted with respect to the normal direction of the current collector, and voids are formed between adjoining active material members. A proportion which the voids account for in the active material layer along any arbitrary direction is 5% or more on a plane which is parallel to the surface of the current collector, and tensile strength of the current collector per 1 μm of height of the active material members is no less than 0.3 N/mm and no more than 1 N/mm.

In an electrode for a lithium secondary battery according to the present invention, a plurality of bumps are regularly arrayed at an interval on the current collector surface, and an active material member is formed on each bump. As a result, it is possible to control the layout of the active material members and the interval between adjoining active material members based on the shape and layout of the bumps.

The growth direction of the active material members is tilted with respect to the normal direction of the current collector. Such active material members are formed by using oblique vapor deposition, for example. In this case, since an active material can be selectively grown on each bump by utilizing a shadowing effect, there is an advantage in that a patterning step as described in Patent Document 2 or Patent Document 3 does not need to be performed.

Moreover, voids are formed between adjoining active material members, such that a proportion which the voids account for in the active material layer along any arbitrary direction is 5% or more on a plane which is parallel to the surface of the current collector. Such a void proportion can be realized based on the shapes and layout of the aforementioned bumps on the current collector surface, the conditions for forming the active material members, and the like. As a result, even if the active material members expand by occluding lithium ions upon charging, spaces for such expansion are guaranteed between active material members, so that the expansion stress acting on the current collector can be alleviated. In particular, when active material members expand so that active material members come into contact with one another, a very large stress acts on the current collector, thus causing deformation of the negative electrode. However, the stress acting on the current collector due to contact between active material members can be reduced when the aforementioned proportion is 5% or more. Furthermore, for an active material layer in which the aforementioned void proportion is 5% or more, the tensile strength of the current collector per 1 μm of height of the active material members is controlled in a proper range, whereby the deformation of the electrode due to expansion stress of the active material members can be greatly reduced.

Therefore, by using an electrode for a lithium secondary battery according to the present invention, a lithium secondary battery having excellent charge-discharge cycle characteristics and a high reliability can be provided.

### EFFECTS OF THE INVENTION

According to the present invention, in an electrode for a lithium secondary battery, contact between adjoining active material members when the active material members expand can be greatly reduced, whereby the stress acting on a current collector can be reduced. Thus, charge-discharge cycle characteristics and reliability can be improved by suppressing the deformation of the current collector due to contraction and expansion of the active material members.

### BRIEF DESCRIPTION OF DRAWINGS

FIG. 1 (a) is a schematic cross-sectional view of an electrode according to an embodiment of the present invention; and (b) is an upper plan view of an active material layer according to an embodiment of the present invention.

FIGS. 2 (a) and (b) are a schematic plan view and a cross-sectional view, respectively, showing the surface configuration of a current collector according to an embodiment of the present invention.

FIG. 3 A schematic cross-sectional view showing an example of a production apparatus for an electrode according to an embodiment of the present invention.

FIG. 4 (a) to (d) are step-by-step cross-sectional views for describing an exemplary method of producing an electrode according to an embodiment of the present invention.

FIG. 5 (a) to (c) are electron micrographs of the upper faces of active material layers according to embodiments of the present invention.

FIG. 6 A cross-sectional view showing a coin-type battery in which an electrode according to the present invention is used.

FIG. 7 A schematic illustration showing a cylindrical battery in which an electrode according to the present invention is used.

FIG. 8 (a) to (c) are schematic step-by-step cross-sectional views for describing a method of producing current collectors according to Examples and Comparative Examples.

FIG. 9 A plan view showing the surface configurations of current collectors according to Examples and Comparative Examples.

FIG. 10 A plan view for describing a measurement method for minimum linear voidages and elongation rates of active material layers according to Examples and Comparative Examples.

FIGS. 11 (a) and (b) are photographs showing cross sections of electrode groups in cylindrical batteries after a constant current charge test.

FIG. 12 A schematic cross-sectional view illustrating another construction of an electrode according to an embodiment of the present invention.

FIG. 13 A plan view showing the surface configuration of an Example current collector.

FIG. 14 Diagrams for describing a method of producing an Example current collector, where (a) is a perspective view of a ceramic roll, and (b) is an enlarged plan view showing the surface configuration of the ceramic roll of (a).

FIGS. 15 (a) and (b) are diagrams showing the surface states of Comparative Example electrodes C2 and C3 after a constant current charge-discharge test, and (c) is a diagram showing the surface state of Example electrode 13 after the test.

### DESCRIPTION OF REFERENCE NUMERALS

100, 300 electrode
11 current collector
12 bump
14 active material member
15 active material layer
16 void
18, 19, 20, 21 arbitrary direction on a plane which is parallel to surface of current collector
D normal direction of current collector surface
S growth direction of active material member
L₂ closest distance
L₁ distance between centers of active material members along direction 18
t thickness of active material layer
41 vacuum chamber
42 gas introducing tube
43 stage
46 crucible
45 oxygen nozzle
49 silicon atom
50 horizontal plane

### BEST MODE FOR CARRYING OUT THE INVENTION

The inventors have studied the causes for electrode plate deformation in an electrode for a lithium secondary battery (hereinafter simply referred to as an “electrode”) occurring through repetitive charging and discharging, to arrive at the following finding.

In the methods of forming an electrode proposed in Patent Document 4 and Patent Document 5, a roughened copper foil is used as the current collector. Irregular ruggednesses are formed on the surface of the roughened copper foil, and by vapor-depositing an active material on such a surface (oblique vapor deposition), active material members are formed. At this time, the width of each active material member and the interval between active material members may become nonuniform due to the ruggednesses of the current collector surface. As a result, it becomes difficult to obtain sufficient voids between active material members, thus leading to a possibility that the intervals between active material members may locally become very narrow.

Therefore, in conventional electrodes, even if active material members are not in contact with one another in a discharging state or an early stage of charging, the expanded active material members may come in contact with one another at a late stage of charging. If active material members come into contact with one another, the stress acting on the current collector will drastically increase, thus making electrode plate deformation likely to occur.

Contact between active material members occurs when the widths of voids between active material members are small relative to the amount by which the widths of the active material members increase through expansion. Therefore, beginning from the portions where the widths of the voids between active material members were the smallest before occlusion of lithium, the active material members will come into contact with one another when the active material members expand through lithium occlusion. Therefore, in order to suppress contact between active material members, it is necessary to ensure that the voids between active material members have sufficient widths on a plane which is parallel to the current collector surface, irrespective of the direction.

Based on this finding, the inventors have conducted further studies to find that, by regularly arraying bumps on the surface of a current collector and selectively growing an active material on these bumps, it becomes possible to control the widths of voids between active material members based on the layout and shapes of the bumps, so that sufficient void widths can be obtained across the entire current collector surface.

On the other hand, in order to suppress deformation of the electrode, it is necessary to ensure tensile strength of the current collector. The inventors have found that different levels of tensile strength are required of a current collector depending on the thickness of its active material layer and the proportion of the voids. Therefore, they have made the finding that deformation of the electrode can be suppressed more effectively by controlling the proportion of the voids in the active material layer and controlling the tensile strength of the current collector in accordance with the proportion of the voids, thus arriving at the present invention.

The present invention is characterized in that, in an electrode for a lithium secondary battery in which a current collector having regularly arrayed bumps on its surface is used, the proportion which the voids account for in the active material layer along any arbitrary direction on a plane which is parallel to the current collector is 5% or more, and that the tensile strength of the current collector per 1 μm of height of an active material member is no less than 0.3 N/mm and no more than 1 N/mm. With such a construction, contact between active material members can be suppressed not only in an early stage of charging but also in a late stage of charging, so that deformation of the electrode due to contact between active material members can be greatly reduced.

### First Embodiment

Hereinafter, with reference to the drawings, a first embodiment of an electrode for a lithium secondary battery according to the present invention will be described. The electrode of the present embodiment is applicable to either a negative electrode or a positive electrode of a lithium secondary battery, but is preferably used as a negative electrode for a lithium secondary battery.

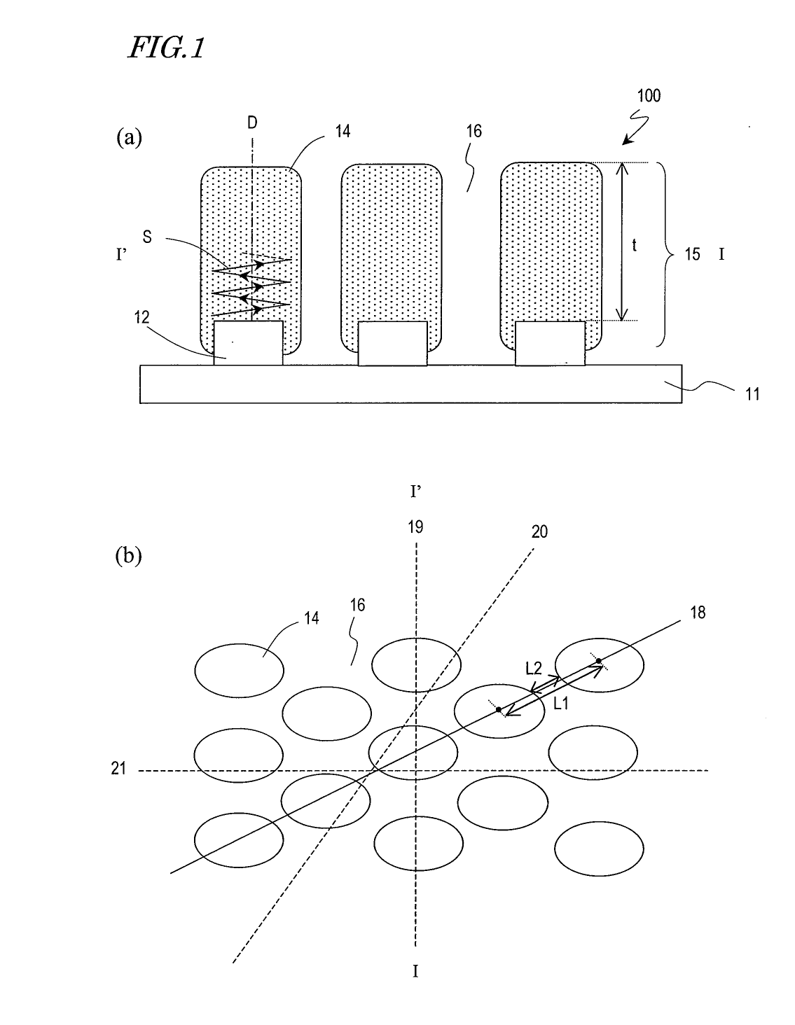

First, FIG. 1(a) and FIG. 1(b) are referred to. FIG. 1(a) is a schematic cross-sectional view of the electrode of the present embodiment, whereas FIG. 1(b) is an upper plan view of an active material layer which has not occluded lithium. Note that FIG. 1(a) shows a cross section along line I-I′ of the active material layer shown in FIG. 1(b).

The electrode 100 includes a current collector 11 having a plurality of bumps 12 on its surface and an active material layer 15 formed on the surface of the current collector 11. The plurality of bumps 12 are regularly arrayed on the surface of the current collector 11 at an interval from one another. To be “regularly arrayed” only means that the interval between adjoining bumps 12 is adjusted to be equal to or greater than a predetermined distance, and defines a notion which does not encompass any surface ruggednesses which are formed through a roughening treatment as described in Patent Document 4 and Patent Document 5 mentioned above. Note that the plurality of bumps do not need to be disposed at an equal interval. Moreover, the bumps 12 do not need to have a substantially identical shape, and the bumps 12 may differ from one another in width or height. Typically, as shown in FIG. 1(b), the bumps 12 are arrayed in a lattice shape (including a houndstooth check).

The active material layer 15 includes active material members 14 respectively formed on the plurality of bumps 12. Voids 16 are formed between adjoining active material members 14. As used herein, an “active material member 14” refers to a pillar-like member which is made of an active material and supported on each bump 12. The “voids 16” refer to voids which are formed between active material members 14 that have not occluded lithium, and do not include any voids which are in the interior of the active material members 14 (e.g., cracks in the active material members 14). Although one active material member 14 is supported on each bump 12 in the illustrated example, two or more active material members 14 may be supported.

The growth directions S of the active material members 14 are tilted with respect to the normal direction D of the current collector 11. The active material members 14 having the growth directions S tilted with respect to the normal direction D can be formed by, for example, allowing silicon to strike the surface of the current collector 11 from a direction which is tilted with respect to the normal direction D of the current collector 11 (oblique vapor deposition) within a chamber in which oxygen gas has been introduced. Note that the normal direction D of the current collector 11 refers to a direction which is perpendicular to an imaginary plane that is obtained by averaging out the ruggednesses on the surface of the current collector 11.

In the illustrated example, each active material member 14 includes a plurality of layers which are stacked on the surface of the current collector 11, such that the respective growth directions S of the plurality of layers are tilted with respect to the normal direction D of the current collector in alternately opposite directions. Such active material members 14 can be formed by performing a plurality of steps of vapor deposition by varying the evaporation direction, for example. The number of layers composing the active material layer 14 is determined by the number of times of evaporation.

In the illustrated example, each active material member 14 has a pillar shape which stands substantially upright with respect to the surface of the current collector 11, but may have a zigzag shape corresponding to the growth directions S. Alternatively, each active material member 14 may have a growth direction S which is tilted only in one direction. However, it would be advantageous to form each active material member 14 from a plurality of layers as described above because the stress acting on the current collector 11 due to a volumetric expansion of the active material members 14 upon lithium ion occlusion can be more effectively alleviated.

As shown in FIG. 1(b), the plurality of active material members 14 in the present embodiment are disposed regularly, corresponding to the layout of the plurality of bumps 12 mentioned above. The plurality of active material members 14 are not in contact with one another, but the voids 16 exist therebetween. Moreover, in a plan view which is parallel to the surface of the current collector 11, the proportion which the voids 16 account for in the active material layer 15 along any arbitrary direction (e.g., directions 18, 19, 20, 21) (which hereinafter may be simply referred to as “linear voidage”) is universally 5% or more. In the present embodiment, the linear voidage of the active material layer 15 can be controlled by appropriately selecting the layout and size of the bumps 12 formed on the surface of the current collector 11, the vapor deposition conditions for the active material members 14, and the like. The specific ranges thereof will be described later.

In the illustrated example, the plurality of active material members 14 are arrayed with an arraying pitch L₁ along the direction 18, such that the active material members 14 are situated closest to one another along the direction 18. That is, the direction 18 defines a distance (closest distance) L₂ between two closest active material members 14. It is assumed that the “closest distance” refers to a minimum value of distance between adjoining active material members 14 on a plane which is parallel to the surface of the current collector 11, i.e., the width of a void between adjoining active material members 14, when each active material member 14 has not occluded lithium ions. In this case, the linear voidage along the direction 18 is expressed as (L₂/L₁)×100(%).

In the present embodiment, the linear voidage along the direction 18 described above is the minimum value of linear voidage along any arbitrary direction (hereinafter, referred to as “minimum linear voidage”). An effect of suppressing electrode plate deformation is obtained when the minimum linear voidage is 5% or more. More preferably, it is 8% or more, whereby contact between active material members 14 can be suppressed with greater certainty. On the other hand, from the standpoint of guaranteeing charge capacity, the minimum linear voidage is preferably 30% or less. More preferably, an average value of linear voidage along any arbitrary direction is 20% or less. As a result, a high charge capacity can be realized with greater certainty.

In the present specification, “linear voidage” and “minimum linear voidage” refer to average values of linear voidage and minimum linear voidage of the active material layer 15 after the electrode 100 is produced and before lithium is occluded. In the case of an electrode whose minimum linear voidage is 8%, the minimum linear voidage after charging and discharging is performed is smaller than 8%, e.g., 6%. Therefore, if the minimum linear voidage of the active material layer 15 before occluding lithium is 8% or more, the minimum linear voidage after initial charging and discharging is performed is 6% or more, so that deformation of the electrode due to repetitive charging and discharging is suppressed. Note that, in some cases, the active material members 14 may come into contact with one another and the active material members 14 may be compressed when initial charging and discharging is performed, so that the minimum linear voidage after charging and discharging may become greater than that before charging and discharging. In the present specification, the minimum linear voidage after initial charging and discharging is performed is referred to as “minimum linear voidage after charging and discharging”, so as to be distinguished from the minimum linear voidage of the active material layer 15 before occluding lithium.

The linear voidage and minimum linear voidage before lithium occlusion or after charging and discharging can be determined by observing the upper face of the active material layer 15 by using a scanning electron microscope (SEM), for example.

In the electrode 100 of the present embodiment, on a plane which is parallel to the current collector 11, the interval (closest distance) between adjoining active material members 14 is controlled so that the linear voidage of the active material layer 15 along any arbitrary direction is 5% or more. Therefore, in a charging state, especially at a late stage of charging, the stress acting on the current collector 11 when each active material member 14 expands to come in contact with an adjoining active material member 14 can be greatly reduced. As a result, a lithium secondary battery having excellent charge-discharge cycle characteristics can be provided.

Preferably, the tensile strength TS_{A} of the current collector 11 in the present embodiment is 6 N/mm or more. As a result, the current collector 11 can have sufficient immunity against expansion and contraction of the active material members 14, so that deformation of the electrode plate can be suppressed more effectively. The tensile strength TS_{A} is more preferably 8 N/mm or more, and still more preferably 10 N/mm or more. The tensile strength is determined by the rupture strength per cross-sectional area of the current collector and the thickness of the current collector, as expressed by the following equation.

tensile strength TS_{A} (N/mm)=rupture strength per cross-sectional area of current collector (N/mm²)×thickness of current collector (mm)

In the present embodiment, “thickness of the current collector” in the above equation refers to the thickness of a portion of the current collector 11 where no bumps 12 are formed on the surface. For example, in the case where the bumps 12 are formed on the surface of a metal foil by plating technique or the like, the thickness of the metal foil is the “thickness of the current collector” as referred to in the above equation. Hereinafter, this will be referred to as “base thickness of the current collector”, so as to be distinguished from the thickness of the entire current collector 11 including the bumps 12.

Moreover, “rupture strength per cross-sectional area of current collector” in the above equation is determined by the material of the metal foil used for the current collector 11 and the like, and is about 400 N/mm² in the case of a rolled copper foil, and about 300 N/mm² in the case of an electrolytic copper foil, for example. In a metal foil containing a copper alloy, e.g., a rolled copper alloy foil or an electrolytic copper alloy foil, the rupture strength per cross-sectional area of the current collector can be made larger (e.g. 460 N/mm² or more) than that of a copper foil. Therefore, it would be advantageous to produce the current collector 11 by using a copper alloy foil because a necessary tensile strength can be ensured while reducing the thickness of the current collector 11.

In the present embodiment, the tensile strength TS_{B} of the current collector 11 per 1 μm of thickness of the active material layer 15 is prescribed to be no less than 0.3 N/mm and no more than 1 N/mm. The tensile strength TS_{B} is given by the following equation.

tensile strength TS_{B} (N/mm)=tensile strength TS_{A} (N/mm)/thickness t of active material layer (μm)

Note that “thickness t of active material layer” in the above equation refers to, as shown in FIG. 1, a thickness t from the upper face of each bump 12 to the upper face of the active material member 14, along the normal direction D of the current collector 11. Moreover, in the case where active material layers are formed on both faces of the current collector, “thickness t of active material layer” in the above equation refers to an average thickness t_{AVE} of the active material layers formed on both faces. Therefore, assuming that the active material layers formed on both faces have thicknesses t_{A} and t_{B}, the tensile strength TS_{B} is expressed as TS_{B}=TS_{A}/t_{AVE}, by using the average thickness t_{AVE}(t_{AVE}=(t_{A}+t_{B})/2) of the active material layer. Furthermore, the thickness t of the active material layer in the above equation is a thickness after the active material layer is formed and before lithium is occluded. The reason is that, if lithium were occluded in the active material layer in advance, or charging and discharging were performed, the active material members composing the active material layer might come into contact with one another to result in a thick active material layer, or a thin active material layer due to elongation of the current collector.

When the tensile strength TS_{B} of the current collector 11 per 1 μm of thickness of the active material layer 15 is 0.3 N/mm or more, deformation of the electrode plate due to expansion/contraction of the active material layer 15 having a linear voidage of 5% or more can be reduced, whereby deteriorations in the charge-discharge characteristics due to deformation of the electrode plate can be suppressed. On the other hand, if the tensile strength TS_{B} of the current collector 11 per 1 μm of thickness of the active material layer 15 is greater than 1 N/mm, a battery with a high energy density cannot be obtained. The reason is that: the tensile strength TS_{B} can be increased by reducing the thickness t of the active material layer 15, or increasing the thickness of the current collector 11 to increase the tensile strength TS_{A}; however, if the thickness t of the active material layer 15 becomes too small or the base thickness of the current collector 11 becomes too large, the capacitance which can be taken out per unit volume of the battery will become small, thus making it impossible to ensure a sufficient energy density of the battery. More preferably, the tensile strength TS_{B} of the current collector 11 per 1 μm of thickness of the active material layer 15 is 0.6 N/mm or more. As a result, deformation of the electrode plate can be suppressed with greater certainty. Thus, by optimizing the relationship between the thickness t of the active material layer 15, which serves as an index of capacitance, and the electrode plate strength (tensile strength TS_{A} of the current collector 11), it becomes possible to improve the energy density of the battery while ensuring a sufficient electrode plate strength. It is a particular advantage that the deformation of the electrode plate can be effectively suppressed even against charging and discharging with a large depth of discharge. Moreover, as the material of the active material layer 15, it would be particularly advantageous to employ a high-capacity active material, e.g., a material containing the Si element (Si-type material) or a material containing the Sn element (Sn-type material), because the aforementioned effect through control of the tensile strength TS_{B} in the aforementioned range will become more pronounced.

In the present embodiment, the bumps 12 are regularly arrayed on the surface of the current collector 11, and it is possible to control the width of the voids 16 between active material members 14 by selecting the layout (interval, arraying pitch) and the size (width, height, etc.) of the bumps 12 as appropriate. Thus, a sufficient linear voidage can be realized along any direction on a plane which is parallel to the surface of the current collector 11.

Hereinafter, with reference to the drawings, preferable layouts and sizes of the bumps 12 according to the present embodiment will be described.

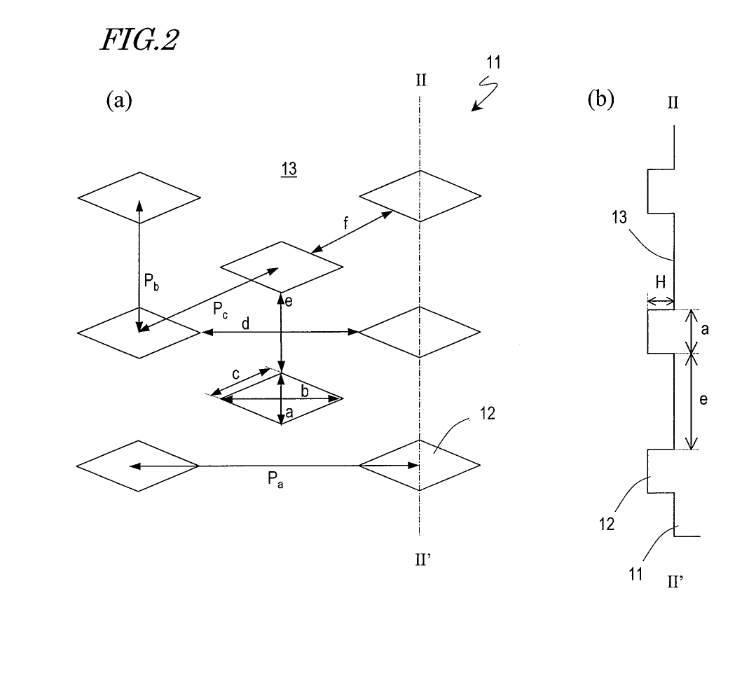

FIG. 2(a) and FIG. 2(b) are a schematic plan view and a II-II′ cross-sectional view, respectively, illustrating the bumps 12 of the current collector 11 according to the present embodiment.

In the illustrated example, the bumps 12 are pillar-like members having diamond-shaped upper faces, but the shape of the bumps 12 is not limited thereto. An orthogonal projection image of a bump 12 as seen from the normal direction D of the current collector 11 may be a polygon such as a square, a rectangle, a trapezoid, a diamond shape, a parallelogram, a pentagon or a home-plate shape, a circle, an ellipse, or the like. The shape of its cross section which is parallel to the normal direction D of the current collector 11 may be a square, a rectangle, a polygon, a semicircular shape, or a shape which is a combination thereof. Moreover, the shape of a bump 12 in a cross section perpendicular to the surface of the current collector 11 may be a polygon, a semicircular shape, an arc shape, or the like, for example. Note that, in the case where the boundaries between the bumps 12 and portions other than the bumps (also referred to as “grooves”, “dents”, etc.) are not clear, e.g., the cross section of the ruggedness pattern formed on the current collector 11 having a shape which is composed of curves, any portion of the entire surface having a ruggedness pattern that has an average height or more will be defined as a “bump 12”, whereas any portion that has less than the average height will be defined as a “groove” or a “dent”. A “dent” may be a single continuous region as in the illustrated example, or may be a plurality of regions which are separated from one another by the bumps 12. Furthermore, the “interval between adjoining bumps 12” as used in the present specification means a distance between adjoining bumps 12 on a plane which is parallel to the current collector 11, referring to “the width of a groove” or “the width of a dent”.

Moreover, in a plan view of the current collector 11 (FIG. 2(a)), the proportion which the total area A1 of the plurality of bumps 12 accounts for in a sum of the total area A1 of the plurality of bumps 12 and the total area A2 of the dents is preferably no less than 10% and no more than 30% (0.1≦{A1/(A1+A2)}≦0.3). Stated otherwise, as seen from the normal direction of the surface of the current collector 11, the proportion which the total area A1 of the plurality of bumps 12 accounts for in the area of the surface of the current collector 11 is preferably no less than 10% and no more than 30%. As used herein, the “area of the surface of the current collector 11” means the area of a region of the surface of the current collector 11 where the active material layer 15 is formed, as seen from the normal direction of the surface of the current collector 11, and does not include any region which lacks the active material layer 15 and which is used as a terminal, for example.

If the above proportion is less than 10%, the possibility that the active material members 14 will be formed in regions other than the bumps 12 will increase, so that sufficient spaces cannot be obtained between adjoining active material members 14. As a result, expansion of the active material members 14 upon charging may not be sufficiently alleviated, and deformation of the electrode plate may occur. On the other hand, if the above proportion exceeds 30%, spaces between adjoining active material members 14 will become insufficient, and thus sufficient spaces for alleviating the expansion of the active material members 14 may not be obtained. On the other hand, by controlling the aforementioned proportion to no less than 10% and no more than 30% as described above, spaces for expansion of the active material members 14 can be secured between adjoining active material members 14 with greater certainty, utilizing a shadowing effect.

The height H of a bump 12 is preferably 3 μm or more, more preferably 4 μm or more, and still more preferably 5 μm or more. If the height H is 3 μm or more, when forming the active material members 14 through oblique vapor deposition, it is possible to dispose the active material members 14 only on the bumps 12 by utilizing a shadowing effect, so that voids 16 can be secured between active material members 14. On the other hand, the height H of the bumps 12 is preferably 15 μm or less, and more preferably 12 μm or less. If the bumps 12 are 15 μm or less, the volumetric ratio which the current collector 11 accounts for in the electrode can be kept small, whereby a high energy density can be obtained.

Preferably, the bumps 12 are regularly arrayed with a predetermined arraying pitch, and may be arrayed in a pattern such as a houndstooth check or a grid. The arraying pitch of the bumps 12 (distance between the centers of the adjoining bumps 12) is no less than 10 μm and no more than 100 μm, for example. As used herein, the “center of a bump 12” means a center point across the largest width of the upper face of the bump 12. If the arraying pitch is 10 μm or more, spaces for the active material members 14 to expand can be secured between adjoining active material members 14 with greater certainty. It is preferably 20 μm or more, and more preferably 30 μm or more. On the other hand, if the arraying pitch P is 100 μm or less, a high capacity can be obtained without increasing the height of the active material members 14. It is preferably 80 μm or less, more preferably 60 μm or less, and still more preferably 50 μm or less. In the illustrated example, the bumps 12 are arrayed along three directions, and it is preferable that the arraying pitches Pₐ, P_{b}, and P_{c} along the respective directions are all within the aforementioned range.

Moreover, the proportion of the interval d of the bumps 12 relative to the arraying pitch Pₐ of the bumps 12 is preferably no less than ⅓ and no more than ⅔. Similarly, the proportion of the intervals e and f of the bumps 12 relative to the arraying pitches P_{b} and P_{c} of the bumps 12 is preferably no less than ⅓ and no more than ⅔. When the proportions of the intervals d, e, and f are ⅓ or more, width of the voids between active material members 14 along the respective arraying directions of the bumps 12 can be secured with greater certainty when the active material members 14 are respectively formed on the bumps 12, so that a sufficient linear voidage is attained. On the other hand, if the proportions of the intervals d, e, and f are greater than ⅔, the active material will be vapor-deposited also in the grooves between bumps 12, so that expansion stress acting on the current collector 11 may increase.

The width of the upper face of a bump 12 is preferably 200 μm or less, more preferably 50 μm or less, and still more preferably 20 μm or less. As a result, it becomes possible to ensure sufficient voids between active material members 14 by utilizing a shadowing effect, so that deformation of the electrode 100 due to expansion stress of the active material can be effectively suppressed. On the other hand, if the width of the upper face of a bump 12 is too small, a sufficient area of contact between the active material member 14 and the current collector 11 may not be obtained; therefore, the width of the upper face of a bump 12 is preferably 1 μm or more. Particularly in the case where the bumps 12 are pillar-shaped, if the width of their upper faces is small (e.g. less than 2 μm), the bumps 12 will be thin, so that the bumps 12 will be likely to be deformed due to stress associated with charging and discharging. Therefore, the width of the upper face of a bump 12 is more preferably 2 μm or more, and still more preferably 10 μm or more, whereby deformation of the bumps 12 due to charging and discharging can be suppressed with greater certainty. In the illustrated example, it is preferable that the widths a, b, and c of the upper face of a bump 12 along the respective arraying directions are all within the aforementioned range.

Furthermore, in the case where the bumps 12 are pillar-like members having side faces which are perpendicular to the surface of the current collector 11, the intervals d, e, and f between adjoining bumps 12 are preferably 30% or more, and more preferably 50% or more, of the widths a, b, and c, respectively, of the bumps 12. As a result, sufficient voids are obtained between active material members 14 to greatly alleviate the expansion stress. On the other hand, if the distance between adjoining bumps 12 is too large, the thickness of the active material layer 14 will be increased in order to ensure a capacity; therefore, the intervals d, e, and f are preferably 250% or less, and more preferably 200% or less, of the widths a, b, and c, respectively, of the bumps 12.

The upper face of each bump 12 may be flat, but preferably has ruggednesses, preferably with a surface roughness Ra of 0.1 μm or more. As used herein, “surface roughness Ra” refers to “arithmetic mean roughness Ra” as defined under the Japanese Industrial Standards (JISB 0601-1994), and can be measured by using a surface roughness measurement system or the like. When the surface roughness Ra of the upper face of each bump 12 is less than 0.1 μm, if a plurality of active material members 14 are formed on the upper face of one bump 12, for example, the width (pillar diameter) of each active material member 14 will be small, so that they are likely to be destroyed during charging and discharging. It is more preferably 0.3 μm or more, thus making it easy for the active material members 14 to grow on bumps 12, whereby sufficient voids can be surely formed between active material members 14. On the other hand, if the surface roughness Ra is too large (e.g. over 100 μm), the current collector 11 will become thick and a high energy density will not be obtained; therefore, the surface roughness Ra is preferably 30 μm or less, for example. It is more preferably 10 μm or less, and still more preferably 5.0 μm or less. In particular, if the surface roughness Ra of the current collector 11 is within the range of no less than 0.3 μm and no more than 5.0 μm, a sufficient adhesion force can be secured between the current collector 11 and the active material members 14, whereby peeling of the active material members 14 can be prevented.

The material of the current collector 11 is preferably copper or a copper alloy which is fabricated by a rolling technique, an electrolysis technique, or the like, and more preferably a copper alloy having a relatively large strength. The current collector 11 in the present embodiment can be obtained by forming a regular ruggedness pattern including the plurality of bumps 12 on the surface of a metal foil, e.g., copper, copper alloy, titanium, nickel, or stainless steel, although there is no particular limitation. As the metal foil, a metal foil such as a rolled copper foil, a rolled copper alloy foil, an electrolytic copper foil, or an electrolytic copper alloy foil is suitably used, for example.

For example, the thickness of the metal foil before the ruggedness pattern is formed thereon is preferably no less than 1 μm and no more than 50 μm, although there is no particular limitation. Volumetric efficiency can be ensured at 50 μm or lower, and handling of the current collector 11 is facilitated at 1 μm or above. The thickness of the metal foil is more preferably no less than 6 μm and no more than 40 μm, and still more preferably no less than 8 μm and no more than 33 μm.

Although there is no particular limitation as to the method of forming the bumps 12, a metal foil may be subjected to an etching utilizing a resist resin or the like, thereby forming a predetermined pattern of grooves on the metal foil, such that any portion where a groove is not formed defines a bump 12, for example. Moreover, a resist pattern may be formed on a metal foil, and bumps 12 may be formed in the groove portions of the resist pattern by an electrodeposition or plating technique. Alternatively, a method may be employed which, by using a rolling roller having grooves formed thereon by pattern engraving, mechanically transfers the grooves on the rolling roller to the surface of a metal foil.

As described earlier, the active material members 14 in the present embodiment grow along a direction(s) S which is tilted with respect to the normal direction D of the current collector 11. The angle between the growth direction S of each active material member 14 and the normal direction D (tilting angle) α is preferably 5° or more, and more preferably 10° or more. In order to obtain good contact, the area of contact between each active material member 14 and the current collector 11 should be as large as possible, that is, tilting angle=0°; however, no shadowing effect will occur in that case, and therefore interspaces cannot be formed between adjoining active material members 14. However, if the above angle is 5° or more, a sufficient area of contact can be obtained while forming interspaces between active material members 14. Moreover, when forming active material members 14 which are tilted in one direction with respect to the normal direction D of the current collector 11, the area of exposed portions of the current collector 11 opposing the positive-electrode active material layer (portions of the surface of the current collector 11 where the active material members 14 are not formed) can be reduced if the angle is 10° or more, so that deposition of lithium in the exposed portions of the current collector 11 may be prevented. On the other hand, the tilting angle α should be less than 90°, but the closer to 90° the tilting angle α is, the more difficult it will be to form the active material members 14. Moreover, the area of the portions of the surface of the current collector 11 where the active material is not deposited because of being shaded by the active material members 14 and the bumps 12 will increase, thus deteriorating the high-rate characteristics of the battery; therefore, it is preferably 80° or less, and more preferably less than 70°. In the case where the active material members 14 are formed by oblique vapor deposition, the tilting angle α of the active material members 14 is determined by the evaporation angle when forming the active material members 14. Note that the tilting angle α can be determined by measuring the tilting angles of two to ten arbitrary active material members 14, and calculating an average value of these values, for example.

The tilting angle α of the active material members 14 may change according to the height of the active material members 14. In the case where each active material member 14 has a plurality of portions with different growth directions S as in the present embodiment, it is preferable that all growth directions S within each active material member 14 are tilted with respect to the normal direction D, and that their tilting angle α is universally 10° or more but less than 90°.

In the present embodiment, it is preferable that the volumetric ratio which the voids 16 account for in the active material layer 15 (hereinafter referred to as “volumetric voidage”) is 10% or more 70% or less. If the volumetric voidage is 10% or more, the expansion and contraction of the active material members 14 can be effectively absorbed by the voids 16, so that deformation of the electrode 100 can be reduced. On the other hand, from the standpoint of ensuring high capacity, it is preferable that the volumetric voidage is 70% or less.

The thickness t of the active material layer 15 is equal to the height of the active material members 14, and refers to the distance t from the upper face of each bump 12 of the current collector 11 to the apex of the active material member 14 along the normal direction of the current collector 11, e.g. 0.01 μm or more, preferably 0.1 μm or more. As a result, a sufficient energy density is ensured, thus making it possible to take advantage of the high-capacity characteristics of the active material containing silicon. Moreover, if the thickness t is 3 μm or more, for example, the volumetric ratio which the active material accounts for in the entire electrode is more increased, whereby an even higher energy density is obtained. It is more preferably 5 μm or more, and still more preferably 8 μm or more. On the other hand, the thickness t of the active material layer 15 is e.g. 100 μm or less, preferably 50 μm or less, and more preferably 40 μm or less. As a result, the expansion stress due to the active material layer 15 can be suppressed, and the collector resistance can be lowered, which is advantageous for high-rate charging and discharging. If the thickness t is e.g. 30 μm or less, and still more preferably 25 μm or less, deformation of the current collector 11 due to expansion stress can be suppressed more effectively.

The thickness t of the active material layer 15 can be measured by the following method, for example. First, the thickness of the entire electrode 100 after forming the active material layer 15 is measured. In the case where the bumps 12 and the active material layer 15 are formed only on one surface of the current collector 11, the thickness t of the active material layer 15 is determined by subtracting the thickness of the current collector 11 including the bumps 12 (a sum of the thickness of the metal foil and the height of the bumps 12) from the thickness of the entire electrode 100. In the case where the bumps 12 and the active material layers 15 are formed on both faces of the current collector 11, the total thickness of the active material layers 15 formed on both faces of the current collector 11 can be determined by subtracting the thickness of the current collector 11 including the bumps 12 (a sum of the thickness of the metal foil and the total height of the bumps 12 formed on both faces) from the thickness of the entire electrode 100.

Although there is no particular limitation, in order to prevent cracks from occurring in the active material members 14 due to expansion at the time of charging, the thickness (width) of the active material members 14 is preferably 100 μm or less, and more preferably 5 μm or less. Moreover, in order to prevent the active material members 14 from peeling from the current collector 11, the width of the active material members 14 is preferably 1 μm or more. The thickness of the active material members 14 is determined from an average value, among two to ten arbitrary active material members 14, for example, of the width of a cross section which is parallel to the surface of the current collector 11 and which is along a face that is at ½ of the height t of the active material members 14. If the aforementioned cross section is substantially circular, it will be an average value of the diameter.

In the present embodiment, it is preferable that the capacity per unit area of the active material layer 15 is equal to or greater than 2 mAh/cm² or more, whereby a high battery energy can be obtained. On the other hand, when the capacity per unit area is increased while ensuring a linear voidage of 5% or more, the thickness of the active material layer 15 (height of the active material members 14) t will increase to induce an increased amount of expansion at the time of charging, so that it may not be possible to sufficiently suppress deformation of the current collector 12 due to expansion stress. Therefore, the capacity per unit area is preferably 8 mAh/cm² or less, and more preferably 10 mAh/cm² or less.

The active material layer 15 in the present embodiment preferably contains the silicon element or the tin element, whereby a high capacity can be ensured. More preferably, it comprises an active material containing the silicon element. The active material layer 15 may include at least one selected from the group consisting of elemental silicon, a silicon alloy, a compound containing silicon and oxygen, and a compound containing silicon and nitrogen, for example. The active material layer 15 may contain only one kind, or two or more kinds of substances, among the aforementioned substances.

The compound containing silicon and nitrogen may further contain oxygen. For example, the active material layer 15 may be composed of a plurality of compounds which contain silicon, oxygen, and nitrogen, such that the molar ratios of these elements are different, or may be composed of a composite of a plurality of silicon oxides having different molar ratios of silicon relative to oxygen.

More preferably, the active material layer 15 contains silicon oxide (SiOₓ, where 0<x<2). Generally speaking, in an active material containing silicon oxide, as the molar ratio x of the oxygen amount relative to the silicon amount (which hereinafter may be simply referred to as “oxygen ratio”) becomes lower, a higher charge-discharge capacity will be obtained, but the coefficient of volumetric expansion due to charging will be increased. On the other hand, as the oxygen ratio x becomes higher, the coefficient of volumetric expansion will be reduced, but the charge-discharge capacity will be lowered. An average value of the oxygen ratio x of the active material layer 15 in the present embodiment is no less than 0.01 and no more than 1, and more preferably greater than 0.1 but less than 1.0, for example. When the average value of the oxygen ratio x is greater than 0.1, expansion and contraction due to charging and discharging is suppressed, whereby the expansion stress acting on the current collector 11 can be suppressed. When the average value of the oxygen ratio x is less than 1.0, a sufficient charge-discharge capacity is ensured, and high-rate charge-discharge characteristics can be maintained. It would be advantageous if the average value of the oxygen ratio x is greater than 0.2 but equal to or less than 0.9, because a good balance between moderate charge-discharge cycle characteristics and high-rate charge-discharge characteristics will be attained.

Moreover, it suffices if the oxygen ratio of each portion having a different growth direction is 0<x<2, and the oxygen ratios of the respective portions may be different. In such a case, the average value of the oxygen ratio x refers to the value of the entire active material layer 15.

In the present specification, the “average value of the molar ratio x of the oxygen amount relative to the silicon amount” of the active material layer 15 is said of a composition excluding any lithium that has been added to or occluded by the active material layer 15. Moreover, it suffices if the active material layer 15 contains any silicon oxide that has the aforementioned oxygen ratio, and the active material layer 15 may contain impurities such as Fe, Al, Ca, Mn, and Ti.

Although a vacuum process such as a vacuum evaporation technique, a sputtering technique, or a CVD technique, or a plating technique, etc., may be used for forming the active material layer 15, it is preferable to employ an oblique vapor deposition such that vapor deposition is performed from a direction which is tilted with respect to the normal direction D of the current collector 11. For example, the active material members 14 can be formed by allowing silicon to strike the surface of the current collector 11 from a direction which is tilted with respect to the normal direction D of the current collector 11, within a chamber in which oxygen gas has been introduced.

Each active material member 14 may be a particle composed of a single crystal, or may be a polycrystalline particle including a plurality of crystallites (crystal grains). Alternatively, it may be a particle composed of a microcrystal having a crystallite size of 100 nm or less, or may be amorphous. The active material members 14 being amorphous or being particles of microcrystal can be confirmed by using X-ray diffraction (XRD), a transmission electron microscope (TEM), or the like. In a diffraction pattern which is obtained through XRD measurement, the particle size of a crystallite is calculated from a full-width at half maximum of a peak having the largest intensity in the range of 2θ=15 to 40°, based on Scherrer's equation. If no sharp peaks are observed in the range of 2θ=15 to 40° but only a broad halo pattern is observed in the diffraction pattern, it can be determined that the active material members 14 are substantially amorphous.

The electrode 100 shown in FIG. 1 can be produced by the following method, for example.

First, a current collector 11 having a plurality of bumps 12 on its surface is produced. The current collector 11 is obtained by using a rolling roller having ruggednesses formed on its surface and transferring the ruggedness shapes onto a copper foil, for example.

Next, by oblique vapor deposition, a plurality of active material members 14 are formed on the surface of the current collector 11, thus obtaining an active material layer 15. Each active material member 14 is disposed on the corresponding bump 12.

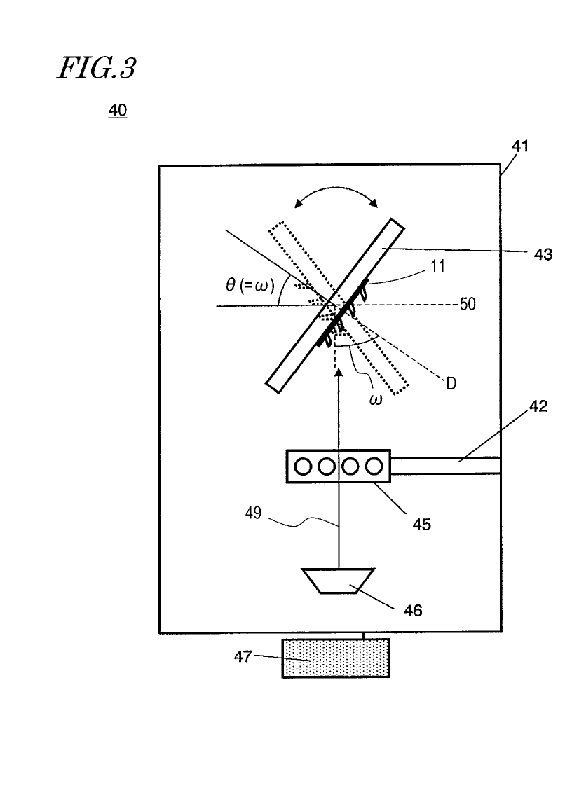

FIG. 3 is a schematic illustration exemplifying the construction of a vapor deposition apparatus used for forming the active material layer 15. The vapor deposition apparatus 40 includes a vacuum chamber 41 and an evacuation pump 47 for evacuating the vacuum chamber 41. In the interior of the vacuum chamber 41, a stage 43 on which to fix the current collector 11, a gas introducing tube 42 for introducing an oxygen gas into the chamber 41, and a crucible 46 loaded with an evaporation source for supplying silicon onto the surface of the current collector 11 are disposed. Silicon can be used as the evaporation source, for example. Although not shown, an electron beam heating means for evaporating the material of the evaporation source is provided. The gas introducing tube 42 includes an oxygen nozzle 45, and is positioned so that the oxygen gas emitted from the oxygen nozzle 45 is supplied to the neighborhood of the surface of the current collector 11. The stage 43 and the crucible 46 are disposed so that vapor-deposition particles from the crucible 46 (which herein are silicon atoms) 49 strike the surface of the current collector 11 from a direction at an angle (evaporation angle) w with respect to the normal direction D of the current collector 11. In this example, the stage 43 has a rotation axis, and as the stage 43 is rotated around this rotation axis, the angle θ of the normal of the stage 43 with respect to the horizontal plane 50 is adjusted to be equal to the predetermined evaporation angle w. Herein, the “horizontal plane” refers to a plane which is perpendicular to the direction in which material of the evaporation source loaded in the crucible 46 is vaporized to travel toward the stage 43.

Formation of the active material layer 15 is performed by, while blowing oxygen gas to the neighborhood of the surface of the current collector 11 from the oxygen nozzle 45, using an electron (EB) gun (not shown) to irradiate the silicon which is loaded in the crucible 46 with an electron beam and dissolve it, thus allowing the silicon to strike the current collector 11 (EB vapor deposition). At the surface of the current collector 11, the silicon atoms 49 and the oxygen gas react, whereby silicon oxide grows. At this time, the silicon atoms 49 strike the surface of the current collector 11 from a direction which is tilted with respect to the normal direction D of the current collector 11, and therefore are likely to be vapor-deposited on the bumps 12 of the surface of the current collector 11, such that silicon oxide grows in pillar shapes only on the bumps 12. On the other hand, at those portions of the surface of the current collector 11 which are shaded by the silicon oxide growing in pillar shapes, silicon atoms do not strike and silicon oxide is not vapor-deposited (shadowing effect).

In this manner, the plurality of active material members 14 are formed on the respective bumps 12 of the current collector 11, whereby the electrode 100 is completed. The average value of the oxygen ratio x in the active material members 14 can be controlled by adjusting the amount of oxygen gas to be introduced to the vacuum chamber 41 (i.e., oxygen concentration in the ambient), for example.

Note that, if vapor deposition is performed with a constant evaporation angle ω in the above method, active material members 14 growing in one direction are obtained. Moreover, while performing an EB vapor deposition, the stage 43 may be rotated along its rotation axis to change the direction in which the current collector 11 is disposed, thus varying the evaporation angle ω. For example, if first to n^{th} (n≧2) vapor deposition steps are performed while varying the evaporation angle ω to form the active material members 14, each resultant active material member 14 can be divided into n portions based on growth directions. In the present specification, these n portions will be referred to as a first portion, a second portion, . . . and an n^{th} portion, as going away from the surface of the current collector 11.

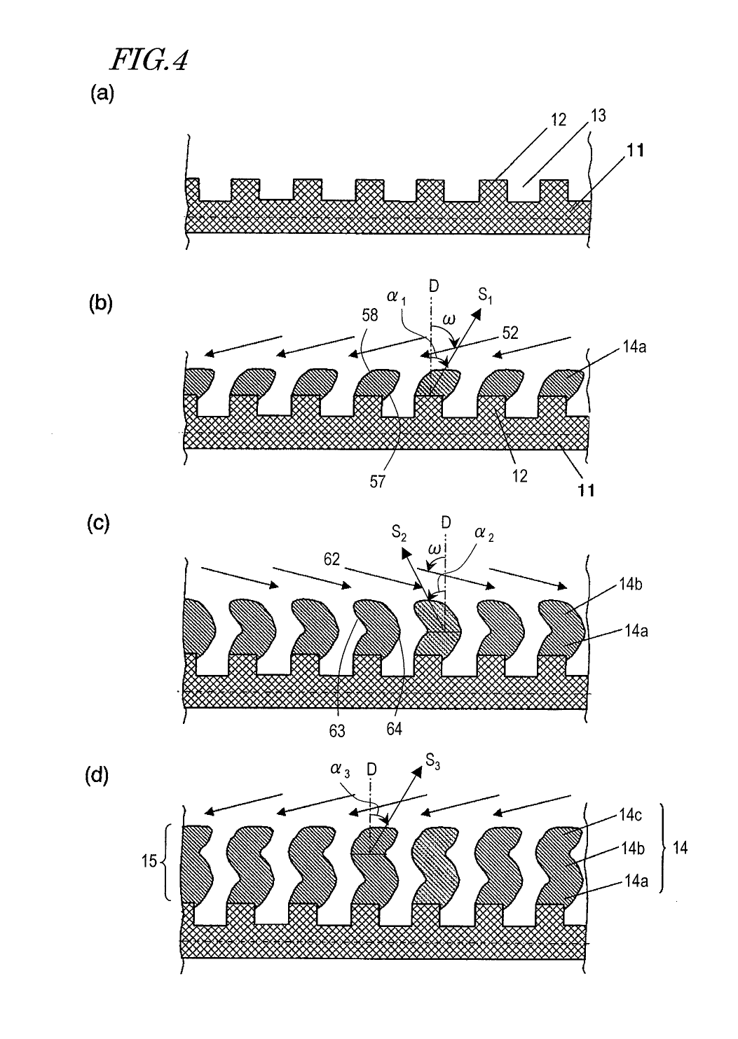

Hereinafter, with reference to the drawings, the method of forming the active material layer 15 by performing a plurality of steps of vapor deposition while varying the evaporation angle ω will be specifically described. FIGS. 4(a) to (d) are schematic step-by-step cross-sectional views for describing an exemplary method of forming the active material layer 15. These figures are perpendicular to the surface of the current collector 11, and illustrate a cross section containing the growth directions of the active material members 14.

First, as shown in FIG. 4(a), a current collector 11 having a plurality of bumps 12 arrayed on its surface is formed. In the cross section shown, the width of the bumps 12 is e.g. 10 μm, and the width of grooves (dents) 13 defined by adjoining bumps 12 is e.g. 20 μm.

Next, the current collector 11 is placed on the stage 43 of the vapor deposition apparatus 40 described with reference to FIG. 3. The stage 43 is disposed so that the angle θ of the normal of the stage 43 with respect to the horizontal plane 50 is 55°, for example. In the crucible 46, Si (scrap silicon: purity 99.999%) is loaded as an evaporation source.

Thereafter, as shown in FIG. 4(b), the silicon in the crucible 46 is evaporated by being heated with an electron beam, thus allowing silicon atoms 49 to strike the bumps 12 of the current collector 11. The direction 52 in which the silicon atoms 49 strike is tilted with respect to the normal direction D of the current collector 11 by an angle ω (which herein is 55°). Moreover, at the same time as allowing the silicon atoms 49 to strike, oxygen (O₂) gas is introduced in the vacuum chamber 41 via the gas introducing tube 42, such that the oxygen gas is supplied from the oxygen nozzle 45 toward the current collector 11. At this time, the interior of the vacuum chamber 41 may be an oxygen ambient having a pressure of 3.5×10⁻² Pa, for example. As a result, silicon oxide (SiOₓ) being obtained from a reaction between Si and oxygen selectively grows on the bumps 12 of the current collector 11, whereby first portions 14a of the active material members are formed (first vapor deposition step). At this time, no silicon atoms 49 adhere upon the grooves 13 between adjoining bumps 12, and silicon oxide does not grow there.

A growth direction S₁ of the first portions 14a is tilted by a tilting angle α₁ with respect to the normal direction D of the current collector 11. The angle α₁ is determined by the evaporation angle (incident angle of silicon) ω. Specifically, it is empirically known that the tilting angle α₁ of the growth direction and the evaporation angle ω of silicon satisfy the relationship of 2 tan α₁=tan ω. It is also known that, by controlling the pressure within the vacuum chamber through changing the amount of oxygen to be introduced, a lower tilting angle than what is calculated from the above relational expression is obtained. Thus, the tilting angle α1 can be controlled by changing the evaporation angle and the pressure within the vacuum chamber.

The resultant first portions 14a have the chemical composition SiOₓ. The average value of the molar ratio x of the oxygen amount relative to the silicon amount is greater than 0.1 but smaller than 1.0. However, the molar ratio x of the oxygen amount relative to the silicon amount in the first portions 14a is small in the neighborhood of a side face (lower side face) 57 of each first portion 14a that is closer to the surface of the current collector 11, and increases toward a side face (upper side face) 58 of each first portion 14a that is farther away from the surface of the current collector 11. Note that the average value of x in the first portions 14a and the thickness of the first portions 14a are controlled by adjusting the output power and time of vapor deposition, the amount of oxygen gas to be introduced to the vacuum chamber 41 (i.e., oxygen concentration in the ambient), and the like.

Next, the stage 43 is rotated clockwise around the rotation axis and is allowed to tilt with respect to the horizontal plane 50, in a direction opposite to the tilting direction of the stage 43 in the aforementioned first vapor deposition step (θ=−55°). Thereafter, as in the first vapor deposition step, the silicon in the crucible 46 is evaporated, and allowed to strike the first portions 14a of the current collector 11. In the cross section shown, a direction 62 in which the silicon atoms 49 are allowed to strike is tilted by e.g. 55° (ω=−55°) with respect to the normal direction D of the current collector 11, in a direction opposite to the aforementioned direction 52. Moreover, as in the first vapor deposition step, at the same time as allowing the silicon atoms 49 to strike, oxygen gas is supplied from the oxygen nozzle 45 toward the current collector 11. As a result, silicon oxide (SiOₓ) grows on each first portion 14a, whereby a second portion 14b of the active material member is formed (second vapor deposition step). In the cross section shown, a growth direction S₂ of the second portions 14b is tilted by an angle α₂(α₂=−α₁) with respect to the normal direction D of the current collector 11, in a direction opposite to the growth direction of the first portions 14a.

The second portions 14b also have an oxygen concentration distribution, similarly to the first portions 14a described above. That is, the molar ratio x of the oxygen amount relative to the silicon amount in the second portions 14b increases from a lower side face 63 toward an upper side face 64 of each second portion 14b. Thus, the direction in which x increases is different between the first portions 14a and the second portions 14b.

Thereafter, as shown in FIG. 4(d), the angle θ of the stage 43 is again brought back to the same angle α s that in the first vapor deposition step (which herein is 55°), thus allowing silicon oxide to grow under conditions similar to those in the first vapor deposition step (third vapor deposition step). As a result, third portions 14c are further formed upon the second portions 14b. A tilting angle α₃ of a growth direction S₃ of the third portions 14c is equal to the tilting angle α₁ of the first portions 14a. Moreover, the oxygen concentration distribution (direction in which x increases) of the third portions 14c is also identical to that of the first portions 14a. In this manner, an active material layer 15 composed of active material members 14 each having three portions 14a to 14c is obtained.

The above method forms the active material layer 15 by performing first to third vapor deposition steps. However, the evaporation angle ω may be alternately switched between 55° and −55°, for example, and vapor deposition may be performed up to a n^{th} time (n≧2), whereby active material members 14 each having n portions can be formed. Although there is no particular limitation as to the vapor deposition time in each vapor deposition step, they are preferably set substantially equal. Therefore, they are preferably set to be 1/n of the total vapor deposition time.

When the active material members 14 are formed through a plurality of vapor deposition steps as in the above method, the resultant active material members 14 has at least one bent portion. As used herein, a “bent portion” refers to a portion at which the tilting direction of an active material member 14 with respect to the normal direction D of the current collector 11 is inverted. In the case where an active material member 14 has a plurality of bent portions, the active material member 14 extends in a zigzag manner from the face of the active material member 14 facing the current collector 11, in a direction away from the current collector 11. As used herein, to “extend in a zigzag manner” means that the active material member 14 extends in a vertical direction from the surface of the current collector 11, while inverting its tilting direction with respect to the normal direction D of the surface of the current collector 11. Thus, when an active material member 14 has a bent portion or extends in a zigzag manner, the stress occurring due to expansion of the active material member 14 can be alleviated at the bent portion, whereby peeling, cracking, and pulverization of the active material members 14 can be suppressed.

In the case where, when forming the active material members 14, a large number (e.g. 30 or more) of vapor deposition steps are performed (n≧30), or the thickness of the portions formed through each vapor deposition step is particularly small (e.g. 0.5 μm or less), a cross-sectional shape of the active material members 14 may not be a zigzag shape which is tilted along the growth directions S, but may be a pillar shape which stands upright along the normal direction D of the current collector 11, as illustrated in FIG. 1(a). Even in such cases, through a cross-sectional observation of the active material members 14, it can be confirmed that the growth directions S of each active material member 14 extend in a zigzag manner from the bottom face toward the upper face. Moreover, as described earlier, each portion of an active material member 14 has an oxygen distribution along the width direction, such that the oxygen concentration is higher at the side face which is an upper-looking face. Therefore, by measuring the oxygen distribution of the active material members 14, the growth directions S, the number of times n of evaporation, and the like can also be confirmed.

When forming the active material layer 15 by utilizing oblique vapor deposition, the linear voidage of the active material layer 15 can be controlled based on vapor deposition conditions. Specifically, in the case of forming an active material layer 15 having active material members 14 which are tilted in one direction, the shape and size (width, height) of the active material members 14 can be adjusted by appropriately selecting conditions such as the evaporation direction, the evaporation angle ω, and the vapor deposition time, whereby the linear voidage of the active material layer 15 can be controlled. Moreover, in the case where the active material members 14 are formed by performing a plurality of vapor deposition steps as in the method described with reference to FIGS. 4(a) to (d), the linear voidage of the active material layer 15 can be controlled by selecting vapor deposition conditions such as the number of times n of evaporation, the evaporation direction of each vapor deposition step, the evaporation angle ω, the vapor deposition rate, and the vapor deposition time.

As an example, the inventors have produced three sample electrodes No. 1 to No. 3 having different vapor deposition conditions (evaporation angle ω), and measured the minimum linear voidage of the active material layer of each, the results of which will be described below.

Each of sample electrodes No. 1 to No. 3 was produced by using a current collector which was formed by a similar method. The current collector was formed by disposing bumps each having a quadrangular prism shape and having a diamond-shaped upper face (diagonal: 10 μm×20 μm) (height: 6 μm) on the surface of a copper foil, at an interval of 20 μm along the longer diagonal, and an interval of 18 μm along the shorter diagonal, of the diamond shape. By using the vapor deposition apparatus 40 described with reference to FIG. 3, an active material layer containing silicon oxide was formed on the surface of each such current collector, whereby sample electrodes No. 1 to No. 3 were obtained. The active material layer of sample electrode No. 1 was formed by performing 35 steps (n=35) of vapor deposition while switching the evaporation angle ω between 55° and −55°. Similarly, the active material layer of sample electrode No. 2 was formed by performing 35 steps (n=35) of vapor deposition while switching the evaporation angle ω between 60° and −60°, and the active material layer of sample electrode No. 3 while switching the evaporation angle ω between 68° and −68°. The thickness t of the active material layers of these sample electrodes was all 14 μm.

FIGS. 5(a) to (c) are electron micrographs showing the upper faces of the active material layers of sample electrodes No. 1 to No. 3, respectively. As shown in FIG. 5(a), the minimum linear voidage of the active material layer of sample electrode No. 1 is a linear voidage along a direction 65 which defines the closest distance between active material members 14. Similarly, the minimum linear voidages of the active material layers of sample electrodes No. 2 and No. 3 are linear voidages along a direction 66 and a direction 67, respectively. The linear voidages along these directions were measured to be about 10% in sample electrode No. 1 (evaporation angle ω=55°, −55°), about 11% in sample electrode No. 2 (evaporation angle ω=60°, −60°), and about 15% in sample electrode No. 3 (evaporation angle ω=68°, −68°). From these results, it has been confirmed that a minimum linear voidage can be controlled by varying the evaporation angle ω when forming an active material layer. In the above sample electrodes, the reason why the minimum linear voidage increases as the evaporation angle ω becomes larger is that, as the evaporation angle ω becomes larger, the shadowing effect is enhanced and thus the regions where the active material (silicon oxide) is not deposited are increased.

The preferable range of evaporation angle ω in the present embodiment is 5° or more, and more preferably 10° or more, for example, although it may change depending on other vapor deposition conditions such as the number of times n of evaporation. This makes it easier to obtain a sufficient linear voidage. The evaporation angle ω may be less than 90°. However, the evaporation angle ωis preferably less than 80°, because, as the evaporation angle ω approaches 90°, it becomes more difficult to form the active material members.

On the other hand, given the same evaporation angle ω, the linear voidage increases as the number of times n of evaporation increases. The reason thereof is as follows. By allowing an n^{th} portion to grow from a direction which is different from that in an (n−1)^{th} step, the portion which was grown in the (n−1)^{th} step (active material pillar) becomes shaded, whereby an effective shadowing effect is exhibited. Thus, since the shadowing effect due to active material pillars can be enhanced by increasing the number of times n of evaporation, the linear voidage increases as the number of times n of evaporation increases.

The preferable range of the number of times n of evaporation in the present embodiment is 2 or more, for example, although it may change depending on other vapor deposition conditions such as the evaporation angle ω. This makes it easier to obtain a sufficient linear voidage. If the number of times n of evaporation is too large, the time required for the vapor deposition process will become long, and the mass producibility will be lowered; therefore, the number of times n of evaporation is preferably 100 or less.

The construction of the electrode of the present embodiment is not limited to the construction shown in FIG. 1. In the example shown in FIG. 1, each active material member 14 is a pillar shape which is stands substantially upright with respect to the surface of the current collector 11, but in the case where the number of times of evaporation for forming the active material members is small (e.g. 20 steps or less), and so on, each active material member may have a zigzag shape corresponding to the growth directions S, as described earlier. Hereinafter, with reference to the drawings, an example of such a construction will be described.

FIG. 12 is a schematic cross-sectional view illustrating the construction of an electrode according to the present embodiment in the case where each active material member has a zigzag shape. For simplicity, constituent elements similar to those in FIG. 1 will be denoted by like reference numerals, and the descriptions thereof are omitted.

An electrode 300 shown in FIG. 12 includes a plurality of active material members 240 respectively formed on bumps 12 of a current collector 11. Each active material member 240 is structured so that a plurality of active material portions having growth directions S that are tilted with respect to the normal direction D of the current collector 11 are stacked, which herein are a first portion 240a to a seventh portion 240g. The growth direction S of each active material portion (e.g., the second portion 240b) and the growth direction S of an immediately underlying active material portion (e.g., the first portion 240a) are tilted toward opposite sides with respect to the normal direction D. The active material members 240 compose an active material layer, such that the active material layer has a linear voidage of 5% or more.

The active material layer of the electrode 300 can be formed by performing seven vapor deposition steps from a first vapor deposition step to a seventh vapor deposition step by a method similar to the method described above with reference to FIG. 4, using the vapor deposition apparatus 40 shown in FIG. 3.

The construction of the vapor deposition apparatus used in the present embodiment is not limited to the construction shown in FIG. 3. For simplicity, the vapor deposition apparatus 40 in FIG. 3 is shown to have a construction where an active material is vapor-deposited on only one face of a fixed current collector that has been cut in a predetermined size; typically, however, it has a construction which allows an active material to be vapor-deposited on both faces of the current collector. For an enhanced producibility, while allowing a sheet-like current collector to travel between a supply roll and a take-up roll, an active material layer may be formed on the surface of the traveling current collector. Furthermore, a plurality of film-forming rolls may be provided in series between a supply roll and a take-up roll, and n steps of vapor deposition may be performed while allowing the current collector to travel in one direction. Moreover, after forming an active material layer on one face of the current collector, the current collector may be inverted to form an active material layer on the other face of the current collector as well. As necessary, a plurality of evaporation sources and oxygen nozzles may be provided within the vacuum chamber.

Next, with reference to the drawings, an exemplary construction of a lithium-ion secondary battery having the electrode 100 of the present embodiment as a negative electrode will be described.

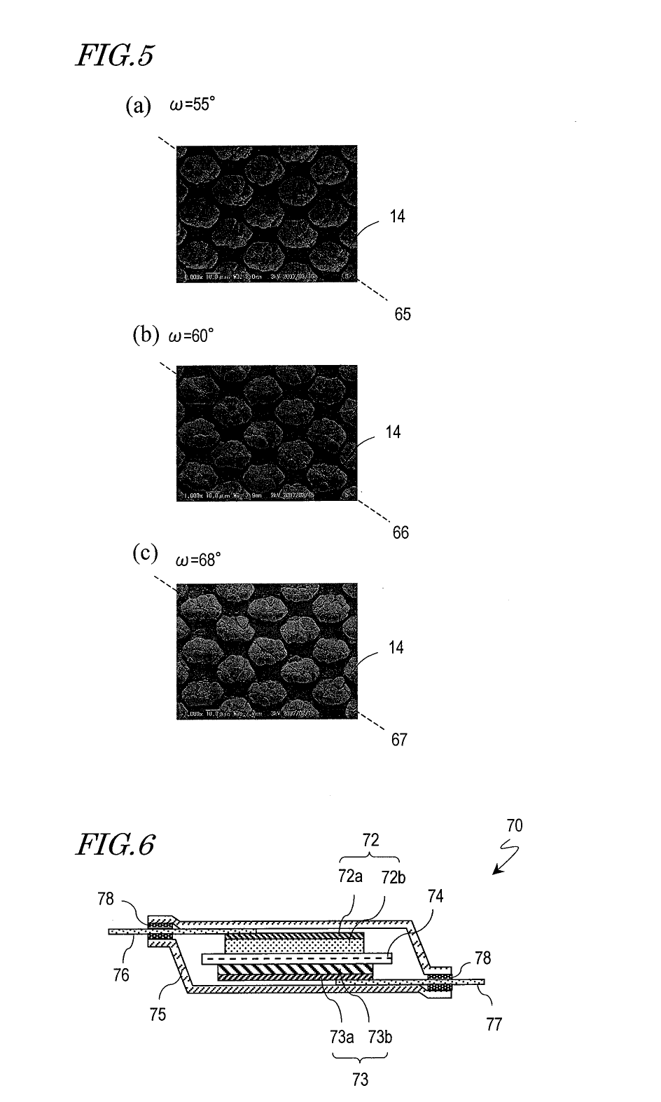

FIG. 6 is a schematic cross-sectional view illustrating a coin-type lithium-ion secondary battery in which the negative electrode of the present embodiment is employed. The lithium-ion secondary battery 70 has an electrode group including a positive electrode 72, a negative electrode 73, and a separator 74 provided between the negative electrode 73 and the positive electrode 72, and an outer case 75 accommodating the electrode group. The positive electrode 72 includes a positive-electrode current collector 72a and a positive-electrode active material layer 72b formed on the positive-electrode current collector 72a. The negative electrode 73 includes a negative-electrode current collector 73a and a negative-electrode active material layer 73b formed on the negative-electrode current collector 73a. The construction of the negative electrode 73 is similar to the construction described above with reference to FIGS. 1(a) and (b), for example. The negative electrode 73 and the positive electrode 72 are disposed so that the negative-electrode active material layer 73b and the positive-electrode active material layer 72b face each other via the separator 74. The positive-electrode current collector 72a and the negative-electrode current collector 73a are connected to one end of the positive electrode lead 76 and one end of the negative electrode lead 77, respectively, whereas the other ends of the positive electrode lead 76 and the negative electrode lead 77 are taken out of the outer case 75. The separator 74 is impregnated with an electrolyte having lithium-ion conductivity. The negative electrode 73, the positive electrode 72, and the separator 74 are accommodated within the outer case 75 together with the electrolyte having lithium-ion conductivity, and are sealed with a resin material 78.

In the lithium-ion secondary battery 70, the positive-electrode active material layer 72b releases lithium ions upon charging, and occludes lithium ions which have been released from the negative-electrode active material layer 73b upon discharging. The negative-electrode active material layer 73b occludes lithium ions which have been released from the positive-electrode active material upon charging, and releases lithium ions upon discharging.

In the present embodiment, there are no particular limitations as to the constituent elements of the lithium-ion secondary battery 70 other than the negative electrode 72. For example, for the positive-electrode active material layer 73b, a lithium-containing transition metal oxide such as lithium cobaltate (LiCoO₂), lithium nickelate (LiNiO₂), or lithium manganate (LiMn₂O₄) can be used, although this is not a limitation. The positive-electrode active material layer 73b may be composed only of a positive-electrode active material, or include a mixture which contains a positive-electrode active material, a binder agent, and a conductive agent. Moreover, the positive-electrode active material layer 73b may be composed of a plurality of active material members, similarly to the negative-electrode active material layer 72b. For the positive-electrode current collector 73a, it is preferable to use a metal such as Al, an Al alloy, or Ti.

As the lithium-ion conductive electrolyte, various solid electrolytes or nonaqueous electrolyte solutions having lithium-ion conductivity may be used. As the nonaqueous electrolyte solution, what is obtained by dissolving a lithium salt in a nonaqueous solvent is preferably used. There is no particular limitation as to the composition of the nonaqueous electrolyte solution. There is no particular limitation as to the separator and the outer case, and any material that is used for lithium secondary batteries of various forms can be used, without limitations. Instead of a separator, a solid electrolyte having lithium-ion conductivity may be used, or a gel electrolyte containing such a solid electrolyte may be used.

A stacked-type battery according to the present invention may have a structure in which positive electrodes and negative electrodes are stacked in three or more layers. However, it is preferable to employ a positive electrode having a positive-electrode active material layer(s) on both faces or one face and a negative electrode having a negative-electrode active material layer(s) on both faces or one face, so that every positive-electrode active material layer opposes a negative-electrode active material layer and every negative-electrode active material layer opposes a positive-electrode active material layer. In the case where a plurality of negative-electrode active material layers are included, the state of tilt (the growth directions, the number of times n of evaporation, the growth direction of the portion obtained through each vapor deposition step, etc.) of the active material members may be identical throughout all of the negative-electrode active material layers, or may differ between negative-electrode active material member layers. Moreover, active material members having different states of tilt may be formed within the same negative-electrode active material layer. Furthermore, in the case where negative-electrode active material layers are formed on both faces of the negative-electrode current collector, the state of tilt of the active material members of the negative-electrode active material layer on each face may be identical or different.

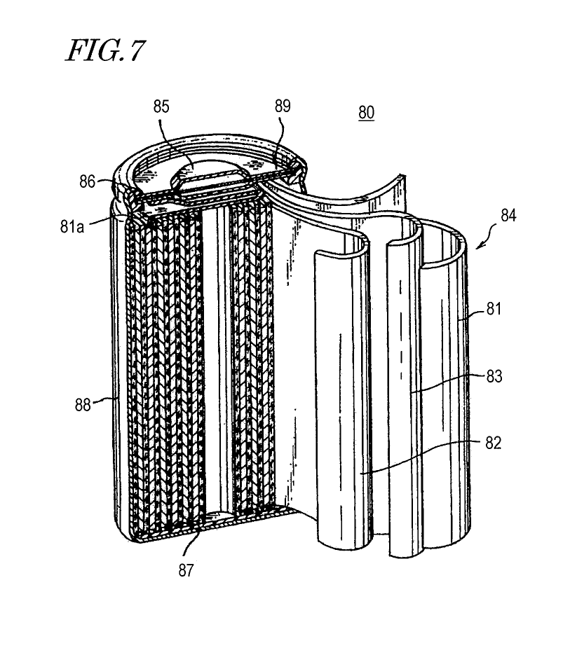

Although FIG. 6 illustrates an example of a stacked-type battery, the lithium secondary battery of the present invention may be a cylindrical battery, a prismatic-type battery, or the like having a wound-type electrode group. FIG. 7 is a schematic cross-sectional view of a cylindrical battery in which electrodes according to the present embodiment are used.

A cylindrical battery 80 includes a group of cylindrical electrodes 84 and a battery can 88 accommodating the same. The electrode group 84 is obtained by winding a strip-like positive electrode plate 81 and a strip-like negative electrode plate 82 together with a wide separator 83 interposed therebetween. The electrode group 84 is impregnated with an electrolyte (not shown) which conducts lithium ions. An aperture of the battery can 88 is closed with a sealing plate 89 having a positive-electrode terminal 85. The positive electrode plate 81 is connected to one end of an aluminum positive electrode lead 81a, whose other end is connected to the rear face of the sealing plate 89. A polypropylene insulation packing 86 is disposed around the brim of the sealing plate 89. The negative electrode plate 82 is connected to one end of a copper negative electrode lead (not shown), whose other end is connected to the battery can 88. An upper insulation ring (not shown) and a lower insulation ring 87 are provided on the top and the bottom, respectively, of the electrode group 84.

Thus, other than the fact that an electrode according to the present invention is used as a negative electrode or a positive electrode, there is no particular limitation as to the constituent elements of a lithium secondary battery according to the present invention, and various materials which are generally used as materials of a lithium-ion battery can be selected.

As follows, Examples of electrodes according to the present invention and Comparative Examples were produced, and two kinds of experiments were performed to evaluate sample batteries in which those electrodes were used. The respective experimental methods and results thereof will be described as [symbol] Examples and Comparative Example—1 [symbol] and [symbol] Examples and Comparative Examples—2 [symbol] .

### Examples and Comparative Example—1

Herein, electrode 1 to electrode 11 were produced as Examples, and electrode C1 was produced as Comparative Example. For each, a minimum linear voidage of the active material layers was measured, and deformation of the electrode (elongation rate) due to constant-current charging was evaluated. Furthermore, sample batteries a and b were produced by using electrode 8 and electrode 10, and subjected to a charge-discharge cycle test. The methods and results thereof will be described.

(i) Method of Producing Electrode

(i-1) Electrode 1

### <Production of Current Collector>

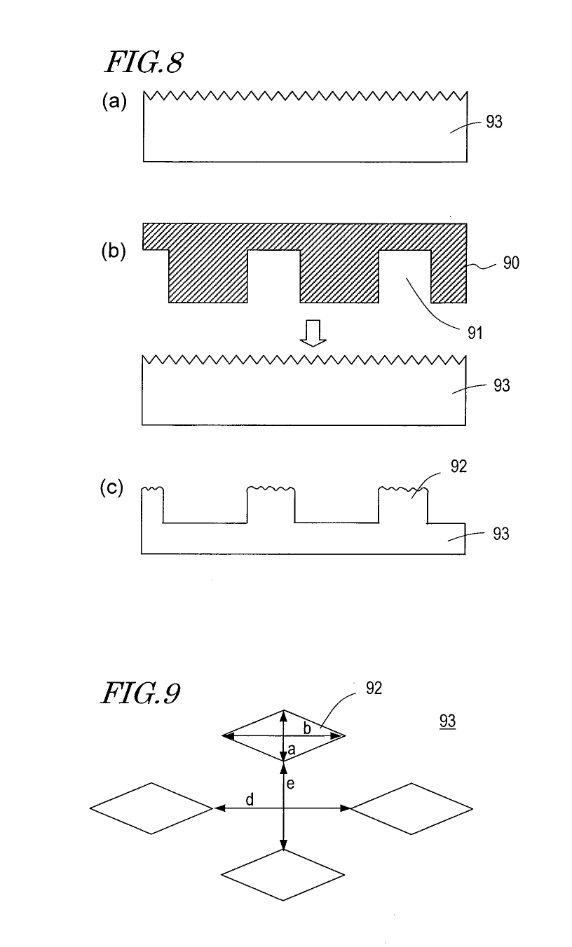

First, a method of producing the current collector which was used in electrode 1 will be described. FIGS. 8(a) to (c) are step-by-step cross-sectional views for describing a method of producing the current collector of the present Example.

As shown in FIG. 8(a), a roughening treatment was performed for both faces of a copper foil (HCL-02Z, manufactured by Hitachi Cable, Ltd.) having a thickness of 27 μm by electrolytic plating technique, thus forming copper particles having a particle size of 1 μm. As a result, a roughened copper foil 93 having a surface roughness Rz of 1.5 μm was obtained. Note that surface roughness Rz refers to the ten point-average roughness Rz as defined under the Japanese Industrial Standards (JISB 0601-1994). Alternatively, a roughened copper foil which is commercially-available for use in a printed-circuit board may be used.

Next, as shown in FIG. 8(b), a plurality of grooves (dents) 91 were formed on a ceramic roller 90 by using laser engraving. The plurality of grooves 91 had diamond shapes, as seen from the normal direction of the ceramic roller 90. Each diamond shape had diagonal lengths of 10 μm and 20 μm. Adjoining dents 91 had an interval of 18 μm along their shorter diagonals, and an interval of 20 μm along their longer diagonals. Each dent 91 had a depth of 10 μm. With a line pressure of 1 t/cm, a roll treatment was performed by passing the copper foil 93 between the ceramic roller 90 and another roller (not shown) which was placed so as to oppose it.

In this manner, as shown in FIG. 8(c), a current collector having a plurality of bumps 92 on its surface was obtained. At this time, regions of the copper foil 93 (having been passed between the rollers) that were pressed by any portion other than the dents 91 of the ceramic roller 90 were smoothed as shown. On the other hand, regions of the copper foil 93 corresponding to the dents 91 recessed into the dents 91 without being smoothed, thus forming the bumps 92. The height of the bumps 92, which was smaller than the depth of the dents 91 of the ceramic roller 90, was about 6 μm.

FIG. 9 is a plan view of the current collector shown in FIG. 8(c). As shown in the figure, the bumps 92 of the current collector correspond to the dents 91 formed on the ceramic roller 90, in terms of shape and arrangement. The upper faces of bumps 92 are substantially diamond shapes, having diagonal lengths a and b of about 10 μm and about 20 μm, respectively. Adjoining bumps 92 had an interval e of 18 μm along the diagonal a, and an interval d of 20 μm along the diagonal b. Furthermore, a ratio (A1/(A1+A2)) of the total area A1 of the bumps 92 to a sum of the total area A1 of the bumps 92 and the total area A2 of the dents 91 was found to be 18%.

<Formation of Active Material Layers>

The current collector obtained with the above method was placed on the stage 43 disposed in the interior of the vacuum chamber 41 shown in FIG. 3, and while supplying an oxygen gas with a purity of 99.7% to the vacuum chamber 41, an EB vapor deposition was performed by using a vapor deposition unit (i.e., a unit form combining an evaporation source, a crucible, and an electron beam generator) and an evaporation source of silicon. The interior of the vacuum chamber 41 had an oxygen ambient with a pressure of 3.5 Pa. In order to evaporate silicon from the evaporation source, the electron beam generated by the electron beam generator was deflected with a deflection yoke so as to be radiated onto the evaporation source. As the evaporation source, a scrap material (scrap silicon, purity: 99.999%) occurring when forming semiconductor wafers was used.

At vapor deposition, the stage 43 was tilted so that the evaporation angle ω was 75°, and a first vapor deposition step was performed in this state, thus forming a portion (first portion) of each active material member corresponding to the first step. The film formation rate for the first portions was about 8 nm/s, with an oxygen flow rate of 30 sccm, and the first portions had a height of 0.4 μm. Next, the stage 43 was rotated clockwise around its center axis, and was tilted in a direction opposite to the tilting direction of the stage 43 in the aforementioned first vapor deposition step, such that the evaporation angle ω was −75°. In this state, a vapor deposition was performed with an oxygen flow rate of 25 sccm, thus forming second portions (second vapor deposition step). Thereafter, the tilting direction of the stage 43 was changed back to the same direction as that in the first vapor deposition step, and a similar vapor deposition was performed with an evaporation angle ω of 75° and an oxygen flow rate of 20 sccm (third vapor deposition step). In this manner, film formation was performed up to a seventh step by reducing the oxygen flow rate from 15 sccm to 10 sccm, 5 sccm, and 1 sccm in a stepwise manner while alternately switching the evaporation angle ω between 75° and −75°; thereafter, eighth through thirty-fifth steps of vapor deposition were performed without introducing oxygen, thus forming active material members having a height of 14 μm. Thus, an active material layer was obtained (height: 14 μm). An average value of the molar ratio x of the oxygen amount relative to the silicon amount of the active material layer was 0.4.

Thereafter, the current collector was removed from the stage 43, and was again placed on the stage 43 so that the opposite face (rear face) from the front face on which the active material layer had been formed faced upward. With a method similar to the above, 35 vapor deposition steps were performed for the rear face of the current collector, thus forming an active material layer (thickness: 14 μm). In this manner, an electrode having active material layers formed on both faces thereof was obtained. The resultant electrode was designated “electrode 1”.

With a tensile tester, the tensile strength of electrode 1 was measured to be 10.1 N/mm. From this measurement value, a tensile strength per 1 μm of active material layer thickness was calculated to be 0.72 N/mm.

(i-2) Electrode 2

By using a current collector similar to that of electrode 1, active material layers were formed with a method similar to that for electrode 1, except that the evaporation angle ω was alternately switched between 70° and −70°. The resultant electrode was designated “electrode 2”.

(i-3) Electrode 3

By using a current collector similar to that of electrode 1, active material layers were formed with a method similar to that for electrode 1, except that evaporation angle ω was alternately switched between 60° and −60°. The resultant electrode was designated “electrode 3”.

(i-4) Electrode 4

A current collector similar to that of electrode 1 was subjected to 3 minutes of heat treatment in a vacuum at 350° C. so as to reduce its tensile strength. Thereafter, with a method similar to that for electrode 1, active material layers (thickness: 14 μm) were formed on both faces of the current collector. The resultant electrode was designated “electrode 4”. Electrode 4 had a tensile strength of 8.2 N/mm, and its tensile strength per 1 μm of active material layer thickness was 0.59 N/mm.

(i-5) Electrode 5

A heat treatment was performed for and active material layers were formed on a current collector with a method similar to that for electrode 4, except that the evaporation angle ω was alternately switched between 60° and −60°. The resultant electrode was designated “electrode 5”.

(i-6) Electrode 6

A current collector produced by a method similar to the method described above with respect to electrode 1 was subjected to 3 minutes of heat treatment in a vacuum at 400° C. so as to reduce its tensile strength. Thereafter, active material layers were formed with a method similar to that for electrode 1. The resultant electrode was designated “electrode 6”. Electrode 6 had a tensile strength of 6.2 N/mm, and its tensile strength per 1 μm of active material layer thickness was 0.44 N/mm.

(i-7) Electrode 7

A heat treatment was performed for and active material layers were formed on a current collector with a method similar to that for electrode 6, except that the evaporation angle ω was alternately switched between 60° and −60°. The resultant electrode was designated “electrode 7”.

(i-8) Electrode 8

A heat treatment was performed for and active material layers were formed on a current collector with a method similar to that for electrode 6, except that: the evaporation angle ω was alternately switched between 65° and −65°; 7 times of evaporation were performed (n=7); and oxygen was introduced at 5 sccm. The molar ratio x of the oxygen amount relative to the silicon amount in each active material layer was approximately constant throughout the active material layer, with an average value of 0.4. However, the height of each portion was 2.0 μm to ensure that the thickness of the respective active material layers formed on the front face and the rear face of the current collector was equal to the active material layer thickness of electrode 1 (14 μm). The resultant electrode was designated “electrode 8”.

(i-9) Electrode 9

Active material layers were formed with a method similar to that for electrode 1, except that the evaporation angle ω was alternately switched between 55° and −55°. The molar ratio x of the oxygen amount relative to the silicon amount in each active material layer was approximately constant throughout the active material layer, with an average value of 0.4. The resultant electrode was designated “electrode 9”.

(i-10) Electrode 10

A heat treatment was performed for and active material layers were formed on a current collector with a method similar to that for electrode 6, except that the evaporation angle ω was alternately switched between 55° and −55°. The resultant electrode was designated “electrode 10”.

(i-11) Electrode 11

A current collector produced by a method similar to the method described above with respect to electrode 1 was subjected to 3 minutes of heat treatment in a vacuum at 370° C. so as to reduce its tensile strength. Thereafter, active material layers were formed with a method similar to that for electrode 1, except that: the evaporation angle ω was alternately switched between 55° and −55°; 7 times of evaporation were performed (n=7); and oxygen was introduced constantly at 5 sccm. However, the height of each portion was 2 μm to ensure that the thickness of the respective active material layers formed on the front face and the rear face of the current collector was equal to that of electrode 1 (14 μm). The resultant electrode was designated “electrode 11”. Electrode 11 had a tensile strength of 7.8 N/mm, and its tensile strength per 1 μm of active material layer thickness was 0.56 N/mm.

(i-C1) Electrode C1

A ruggedness pattern was formed on a copper foil to form a current collector. In the ruggedness pattern, a ratio (A1/(A1+A2)) of the total area A1 of the bumps to a sum of the total area A1 of the bumps and the total area A2 of the dents was 23%. On the surfaces of the resultant current collector, active material layers with a thickness of 20 μm were formed by oblique vapor deposition, with an evaporation angle ω of 60°. Unlike in other electrodes 1 to 11, the evaporation direction was not switched during vapor deposition. As a result, each active material layer was composed of active material members which were tilted in one direction with respect to the normal of the current collector surface. Thus, “electrode C1” was obtained.

(ii) Measurement of Linear Voidage

By using a scanning electron microscope (SEM), the surfaces of the electrodes of Examples and Comparative Example above were observed, and their minimum linear voidage was measured by the following method.

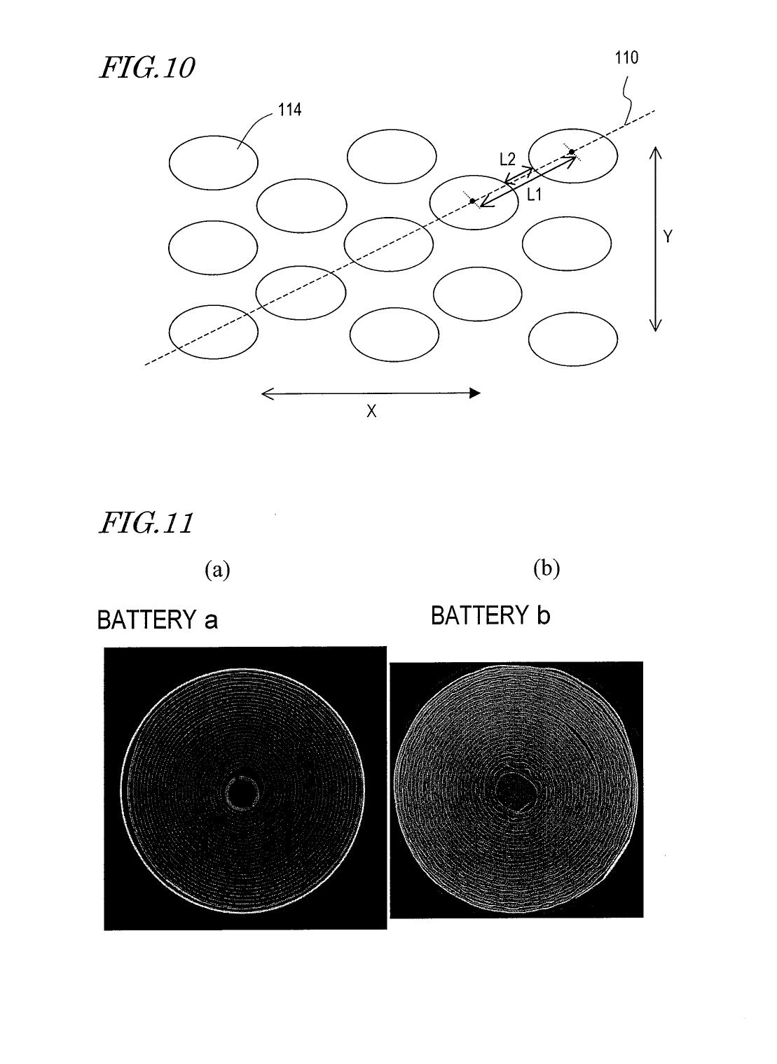

FIG. 10 is a diagram schematically showing the surface of an electrode. As shown in FIG. 10, in the electrodes of Examples and Comparative Example, on the upper face of each electrode, a line 110 containing the closest distance between two most closely-situated active material members 114 substantially coincides with a line connecting the centers of the active material members 114. Therefore, a ratio of the closest distance L₂ to the distance L₁ between the centers of these active material members was calculated, and an average value among ten points was defined as the minimum linear voidage. In this figure, “the X axis” is parallel to the longer diagonal of the upper face (diamond shape) of each bump formed on the current collector surface, whereas “the Y axis” is parallel to the shorter diagonal of the upper face of each bump.

The measurement results are shown in Table 1. The “thickness of active material layer” described in Table 1 refers to an average thickness between the respective active material layers formed on the front face and the rear face of the current collector. As described earlier, in each electrode of these Examples and Comparative Example, the active material layers formed on the front face and the rear face are equal in thickness.

TABLE 1

| | | | | | | tensile | | | |
|---|---|---|---|---|---|---|---|---|---|
| | | | | | | strength | | | minimum |
| | | | | | | of | | | linear |
| | | | | | | current | | | voidage |
| | | | | | | collector | | | after |
| | | | | thickness | tensile | per 1 μm | | | constant- |
| | number | | area ratio | of | strength | of active | | | current |
| | of | | of bump | active | of | material | minimum | | charging |
| | times | Evaporation | regions | material | current | layer | linear | Elongation | and |
| | of | angle | A1/(A1 + A2) | layer | collector | thickness | voidage | rate | discharging |
| | evaporation | ω [°] | [%] | [μm] | [N/mm] | [N/mm] | [%] | [%] | [%] |
| Electrode 1 | 35 | 75 | 18 | 14 | 10.1 | 0.72 | 24.3 | 0 | |
| Electrode 2 | 35 | 70 | 18 | 14 | 10.1 | 0.72 | 18.1 | 0 | |
| Electrode 3 | 35 | 60 | 18 | 14 | 10.1 | 0.72 | 8.2 | 0.8 | |
| Electrode 4 | 35 | 75 | 18 | 14 | 8.2 | 0.59 | 21.2 | 0 | |
| Electrode 5 | 35 | 60 | 18 | 14 | 8.2 | 0.59 | 9.3 | 1.2 | 15 |
| Electrode 6 | 35 | 75 | 18 | 14 | 6.2 | 0.44 | 23.2 | 0 | |
| Electrode 7 | 35 | 60 | 18 | 14 | 6.2 | 0.44 | 9.1 | 1.5 | |
| Electrode 8 | 7 | 65 | 18 | 14 | 6.2 | 0.44 | 8.1 | 2.8 | |
| Electrode 9 | 35 | 55 | 18 | 14 | 10.1 | 0.72 | 5.8 | 2.1 | 8 |
| Electrode | 35 | 55 | 18 | 14 | 6.2 | 0.44 | 7.8 | 4.2 | |
| 10 | | | | | | | | | |
| Electrode | 7 | 55 | 18 | 14 | 7.8 | 0.56 | 6.4 | 4.8 | |
| 11 | | | | | | | | | |
| Electrode | 1 | 60 | 23 | 20 | 4.2 | 0.21 | 3.2 | 12 | 5.2 |
| C1 | | | | | | | | | |

From the results of Table 1, the minimum linear voidages of Example electrodes 1 to 11 were all confirmed to be greater than 5%. In these Examples and Comparative Example, given the same number of times n of evaporation, the minimum linear voidage increased as the evaporation angle ω increased; and given the same evaporation angle ω, the minimum linear voidage increased as the number of times n of evaporation increased. Note that, between electrode 1 and electrode 4, for example, there is a difference in linear voidage of about 3%, despite the same number of times n of evaporation and the same evaporation angle ω; however, this is within the range of measuremental errors.

The minimum linear voidage of Comparative Example electrode C1 was 3.2%, which is smaller than 5%. Sufficient voids were not obtained between active material members presumably because a current collector having a relatively large area ratio of bump regions was used and because the active material layers were formed through vapor deposition (number of times n of evaporation=1) from only one direction.

(iii) Evaluation of Elongation Rate

First, by using each electrode of Examples and Comparative Example described above, a battery sample for elongation rate evaluation was produced.

Each electrode of Examples and Comparative Example described above was shaped so that its electrode size was 15 mm by 15 mm, and was placed so as to oppose a counter electrode (metal lithium) via a separator, whereby an electrode group was obtained. As the separator, a porous film of polyethylene having a thickness of 16 μm (manufactured by Asahi Kasei Chemicals Corporation) was used. This electrode group was inserted in an outer case made of an aluminum laminate sheet, and after an electrolyte solution was further injected, the Al laminate was sealed. As the electrolyte solution, a nonaqueous electrolyte solution was used which was obtained by dissolving LiPF₆ at a concentration of 1.2 mol/L in a solvent in which ethylene carbonate (EC) and ethyl methyl carbonate (EMC) were mixed at a volume ratio of 1:1. In this manner, battery samples for elongation rate evaluation were completed.

In these battery samples, each electrode of Examples and Comparative Example is a positive electrode, whereas the metal lithium is a negative electrode. However, similar results to the following would also be obtained by producing a battery sample in which each electrode of Examples and Comparative Example is a negative electrode, and performing a constant current charge test.

Next, constant-current charging of these battery samples was carried out. In the constant-current charging, the end voltage was 0 V (relative to Li potential), and the current value was 0.1 mA/cm². The charge capacity of each battery sample was about 6 mAh/cm², regardless of the sample.

Each battery sample having experienced constant-current charging was disassembled, and after being cleaned with dimethyl carbonate (DMC), it was dried. Next, the lengths along the X axis and the Y axis of the electrode of each battery sample after charging (after constant-current charging) were measured to calculate an electrode size after charging, and an elongation rate relative to the electrode size before charging (15 mm×15 mm) was determined. Note that the X axis and the Y axis mentioned above are identical to the X axis and the Y axis shown in FIG. 10. Specifically, the “elongation rate” was determined according to the following equation:

(product of lengths along X axis and Y axis of electrode after charging−product of lengths along X axis and Y axis of electrode before charging)/(product of lengths along X axis and Y axis of electrode before charging).

The measurement results of the elongation rate are shown in Table 1. It was found from these results that, when employing Comparative Example electrode C1, in which the minimum linear voidage was as small as less than 5% (and less than 6% after charging and discharging) and the tensile strength of the current collector per 1 μm of active material layer thickness was small, the elongation rate due to charging was as high as 12%, indicative that the electrode had been considerably deformed. This is presumably because of an insufficient strength of the current collector although the stress acting on the current collector due to contact between active material members was large because of small voidage. In contrast, it was found that, by employing Example electrodes 1 to 11, in which the minimum linear voidage is 5% or more and the tensile strength of the current collector per 1 μm of active material layer thickness is 0.3 N/mm or more, the elongation rate due to charging can be reduced to less than 5%. It was also confirmed that, by employing Example electrodes 1 to 8 whose minimum linear voidage is 8% or more, the elongation rate due to charging can be reduced to less than 3%, thus particularly effectively suppressing deformation of the electrode.

Furthermore, when the minimum linear voidage was very large (e.g. 18% or more), active material members were unlikely to come into contact with one another even upon charging, so that the elongation rate was zero regardless of the tensile strength of the current collector; however, as the minimum linear voidage became smaller (e.g. 10% or less), the tensile strength of the current collector exerted greater influence on the elongation rate. For example, although the minimum linear voidages of electrode 3 and electrode 8 were substantially equal, the elongation rate (0.8%) of electrode 3 including a current collector with a large tensile strength was lower than the minimum linear voidage (2.8%) of electrode 8 including a current collector with a small tensile strength. Thus, it was found that, in order to surely reduce the elongation rate of the electrode, it is important to control the tensile strength of the current collector in a proper range, in accordance with the minimum linear voidage of the active material layers.

(iv) Measurement of Linear Voidage after Constant-Current Charging and Discharging

As electrode 5, electrode 9, and Comparative Example electrode C1, battery samples were produced by a method similar to (iii) above, and their linear voidages after conducting a single instance of constant-current charging and discharging were measured by the following method.

First, for each battery sample, a constant-current charging was carried out under the conditions that the end voltage was 0 V (relative to Li potential) and the current value was 0.1 mA/cm². The charge capacity of each battery sample was about 6 mAh/cm², regardless of the sample. Next, discharging was carried out under the conditions that the current value was 0.1 mA/cm² and the end voltage was 1.5 V (relative to Li potential). After the discharging, each battery sample was disassembled, and the minimum linear voidage after constant-current charging and discharging of each electrode was measured by a method similar to the method described in (ii) above.

The measurement results are shown in Table 1. It was found from these results that, so long as the active material layers before occluding lithium have sufficient linear voidage, linear voidage after charging and discharging (after constant-current charging and discharging) can be guaranteed (e.g. 6% or more), and deformation of the electrode can be suppressed. Note that the minimum linear voidages after charging and discharging of electrode 5, electrode 9, and electrode C1 all became greater than their minimum linear voidages before charging and discharging (before lithium occlusion). This is presumably because active material members came into contact with one another at the time of charging and discharging so that each active material members was compressed.

(v) Evaluation of Electrode Deformation in Actual Battery (Cylindrical Battery)

Cylindrical batteries were produced whose negative electrodes were electrodes produced by methods similar to those of Example electrode 8 and electrode 10, and they were subjected to a constant current charge test. The cylindrical batteries were produced as follows.

First, a method of producing a cylindrical positive electrode for a battery is described. Ninety-three parts by weight of LiCoO₂ powder as a positive-electrode active material and 4 parts by weight of acetylene black as a conductive agent were mixed. To the resultant powder, an N-methyl-2-pyrrolidone (NMP) solution of polyvinylidene fluoride (PVDF) as a binder agent (product # 1320 manufactured by KUREHA CORPORATION) was mixed so that the weight of PVDF was 3 parts by weight. To the resultant mixture, an appropriate amount of NMP was added, whereby a paste of positive electrode mixture was prepared. The resultant paste of positive electrode mixture was applied on both faces of a positive-electrode current collector (thickness: 15 μm) made of an aluminum (Al) foil by doctor blade technique, and this was thereafter rolled, whereby a positive-electrode active material layer having a density of 3.5 g/cc and a thickness of 160 μm was formed. By sufficiently drying this at 85° C., a positive electrode sheet was formed. This positive electrode sheet was cut to obtain a positive electrode sized 58 mm×890 mm. In a part of the region of the positive-electrode current collector surface that did not oppose the negative-electrode active material layer, the aluminum foil of the positive-electrode current collector was exposed, and an Al positive electrode lead was welded to the exposed aluminum foil. Thus, a cylindrical positive electrode for a battery was obtained.

Next, with methods similar to those for electrode 8 and electrode 10, cylindrical negative electrodes for a battery, each sized 58.5 mm×900 mm, were obtained.

Thereafter, an electrode group was constructed by allowing a polyethylene separator to be interposed between each cylindrical negative electrode for a battery and a positive electrode, and winding them. This electrode group was inserted in a battery can, and the battery can was sealed after an electrolyte solution was injected therein. In this manner, a cylindrical battery of 18650 size was completed. The cylindrical battery having the negative electrode obtained by using electrode 8 was designated “battery a” whereas the cylindrical battery having electrode 10 as the negative electrode was designated “battery b”.

For the resultant batteries a and b, constant-current charging was carried out with a end voltage of 4.2 V and a current value of 50 hours rate, and thereafter deformation of the negative electrodes in these batteries a and b was observed through CT (Computed Tomography) cross-sectional observation.

FIGS. 11(a) and (b) are cross-sectional photographs of the negative electrodes of battery a and battery b. Based on these results, no deformation of the electrode was observed in battery a in which an electrode (negative electrode) having a minimum linear voidage of 8.1% and an elongation rate at full charge of 2.8% was used; however, electrode buckling was confirmed in battery b in which an electrode (negative electrode) having a minimum linear voidage of 7.8% and an elongation rate at full charge of 4.2% was used, indicative of electrode deformation. Note that, “electrode buckling” refers to the bending of an electrode plate due to expansion stress as shown in FIG. 11(b); when buckling occurs, an electrode has a meandrous cross section.

Thus, it was found that, by controlling minimum linear voidage to 8% or more, elongation rate at full charge can be reduced to about 4% or less, so that electrode deformation due to repetitive charging and discharging, e.g., buckling, can be suppressed more effectively. Although not shown, when a similar evaluation test was performed on a battery which was produced by using Comparative Example electrode C1, electrode C1 exhibited a deformation which was greater than that of the negative electrode (electrode 10) shown in FIG. 11(b).

### Examples and Comparative Examples—2

Herein, electrode 12 to electrode 16 were produced as Examples, and electrodes C2 and C3 were produced as Comparative Examples. For each, a minimum linear voidage of the active material layer was measured, and the electrode plate strength was evaluated. Furthermore, sample batteries were produced whose respective negative electrodes were electrode 12 to electrode 16 and electrodes C2 and C3, and presence or absence of deformation of the electrode due to charging and discharging was examined. The methods and results thereof will be described.

(i) Method of Producing Electrode

(i-12) Electrode 12

### <Production of Current Collector>

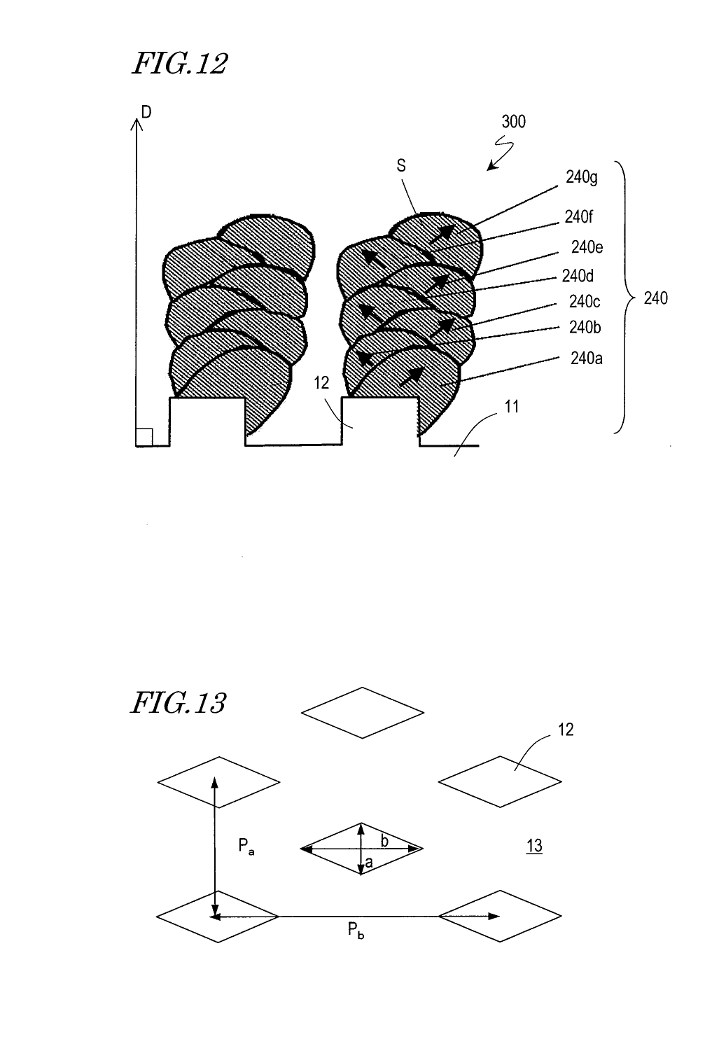

A rolled alloy copper foil (HCL-305 manufactured by Hitachi Cable, Ltd.) having a thickness of 18 μm was cut into a size of 80 mm×15 mm, and by plating technique, a plurality of bumps 12 each having a diamond-shaped upper face was formed on one face thereof, as shown in FIG. 13. Specifically, first, a resist film was exposed and developed on the aforementioned copper foil, thus forming a resist pattern covering regions of the copper foil surface to become regions (dents) 13 other than the bumps 12. Next, on the regions of the copper foil surface that were not covered by the resist pattern, copper particles were allowed to deposit by electrolysis technique. Thereafter, the resist was removed, whereby bumps 12 in quadrangular prism shapes having a height of 5 μm were obtained. The upper face of each bump 12 was a diamond shape having a diagonal a of 10 μm and a diagonal b of 30 μm. The arraying pitch Pₐ of the bumps 12 along the diagonal a was 28 μm, whereas the arraying pitch P_{b} of the bumps 12 along the diagonal b was 64 μm. Furthermore, in the upper plan view shown in FIG. 13, a ratio (A1/(A1+A2)) of the total area A1 of the bumps 12 to a sum of the total area A1 of the bumps 12 and the total area A2 of the dents 13 was 23%. Then, a plurality of bumps 12 were also formed on the other face of the copper foil by a similar method. Thus, a current collector of electrode 12 was obtained.

<Formation of Active Material Layers>

The current collector obtained with the above method was placed on the stage 43 of the vacuum chamber 41 shown in FIG. 3. The stage 43 was tilted with respect to the horizontal plane 50 so that the evaporation angle ω was 65° (ω=65°). In this state, while supplying oxygen gas to the vacuum chamber 41, silicon was evaporated from the evaporation source, thus forming silicon oxide on each bump of the current collector surface. The acceleration voltage of an electron beam with which the evaporation source was irradiated was −8 kV, with the emission (beam current) being set to 260 mA. The oxygen flow rate was 20 sccm, and the vapor deposition time was 7.5 minutes. Thus, first portions of the active material members were formed (first vapor deposition step).

Next, the stage 43 was rotated clockwise around its center axis, and was tilted in a direction opposite to the tilting direction of the stage 43 in the aforementioned first vapor deposition step, such that the evaporation angle ω was −65°, thus forming second portions of the active material members (second vapor deposition step).

Thereafter, up to seventh portions of the active material members were formed while alternately switching the evaporation angle ω between 65° and −65°, whereby an active material layer including pillar-like active material members each composed of 7 layers was obtained.

Next, the current collector was removed from the stage 43, and was again placed on the stage 43 so that the opposite face (rear face) from the front face on which the active material layer had been formed faced upward. With a method similar to the above, vapor deposition steps were performed for the rear face of the current collector, thus forming an active material layer composed of 7 layers. In this manner, electrode 12 having active material layers formed on both faces was obtained.

The thicknesses of the active material layers formed on the front face and the rear face of the current collector of electrode 12 were both 20 μm. The amount of oxygen contained in the resultant active material layer was quantified by combustion method, which indicated that the average value of the molar ratio x of the oxygen amount relative to the silicon amount in the active material layer was 0.6, and that the composition of the compound containing silicon and oxygen was SiO_{0.6}.

Furthermore, the tensile strength (electrode plate strength) of electrode 12 was 14.0 N/mm, and from this value, the tensile strength per 1 μm of active material layer thickness was determined to be 0.70 N/mm.

(i-13) Electrode 13

Electrode 13 was produced by using a method and conditions similar to those for electrode 12, except that the current collector was subjected to 1 hour of heat treatment in an inert ambient at 400° C. so as to reduce the tensile strength of the current collector before forming active material layers on the surfaces of the current collector.

Electrode 13 had a tensile strength of 10.4 N/mm. From this value, the tensile strength per 1 μm of active material layer thickness was determined to be 0.52 N/mm.

(i-14) Electrode 14

Production of electrode 14 was performed with a method and conditions similar to those for electrode 13, except that active material members (number of layers: 5 layer) each composed of first to fifth portions were formed on both faces of the current collector by performing first to fifth vapor deposition steps and that the vapor deposition time of each step was 10.5 minutes.

The thickness of the active material layers formed on the front face and the rear face of the current collector of electrode 14 were both 20 μm. The amount of oxygen contained in the resultant active material layer was quantified by combustion method, which indicated that the composition of the compound containing silicon and oxygen was SiO_{0.6}. Moreover, electrode 14 had a tensile strength of 10.4 N/mm similarly to electrode 13, and its tensile strength per 1 μm of active material layer thickness was determined to be 0.52 N/mm.

(i-15) Electrode 15

### <Production of Current Collector>

A roughening treatment was performed for both faces of a rolled alloy copper foil (HCL-02Z, manufactured by Hitachi Cable, Ltd.) having a thickness of 26 μm by electrolytic plating technique, thus forming copper particles having a particle size of 1 μm. As a result, a roughened copper foil having a surface roughness Rz of 1.5 μm was obtained. Note that, surface roughness Rz refers to the ten point-average roughness as defined under the Japanese Industrial Standards (JISB 0601-1994).

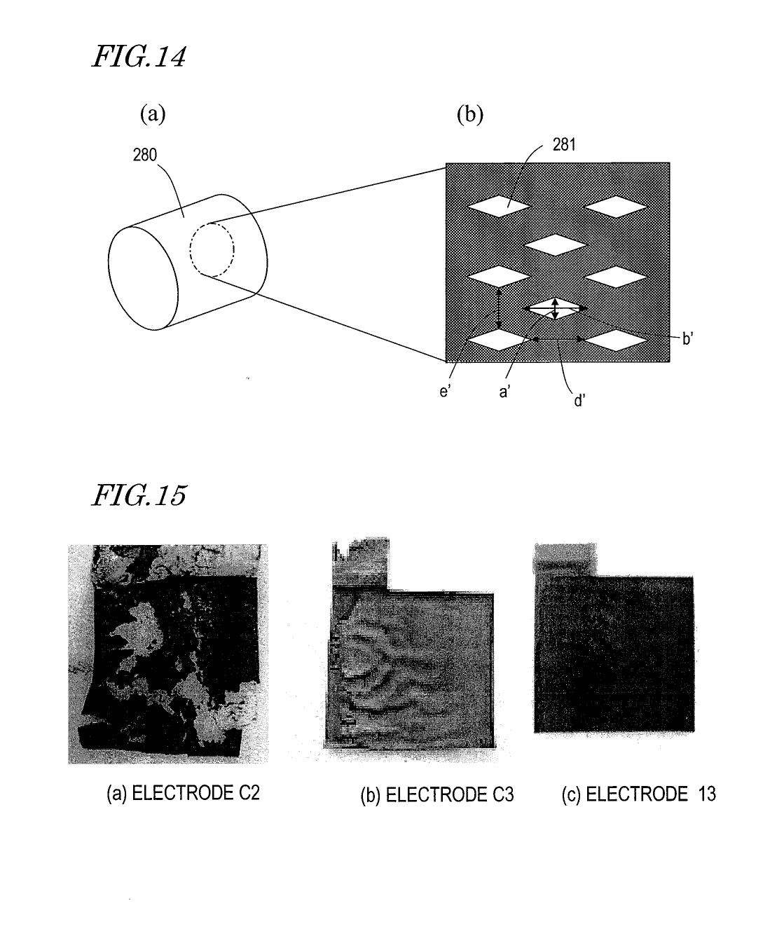

Next, as shown in FIGS. 14(a) and (b), a plurality of grooves (dents) 281 were formed on a ceramic roller 280 by using laser engraving. FIG. 14(a) is a perspective view of the ceramic roller 280, and FIG. 14(b) is a schematic enlarged plan view showing the surface configuration of the ceramic roller 280.

The plurality of dents 281 had diamond shapes, as seen from the normal direction of the surface of the ceramic roller 280. Each diamond shape had a diagonal a′ with a length of 12 μm and a diagonal b′ with a length of 23 μm. Adjoining dents 281 had an interval e′ of 18 μm along the diagonal a′ and an interval d′ of 23 μm along the diagonal b′. Each dent 281 had a depth of 10 μm.

Next, with a line pressure of 1.2 t/cm, a copper foil (roughened copper foil) having been subjected to the above roughening treatment was passed between the ceramic roller 280 and another roller (not shown) which was placed so as to oppose it, thus performing a roll treatment. As a result, a plurality of bumps having shapes corresponding to the aforementioned dents 281 were formed on the roughened copper foil, while the regions of the roughened copper foil where no bumps were formed became dents.

Each bump formed by the above method had a height of 6 μm, and the upper face of each bump had a diamond shape whose diagonal a was 11 μm and whose diagonal b was 22 μm. The arraying pitch Pₐ along the diagonal a was 30 μm, and the arraying pitch P_{b} along the diagonal b was 46 μm. This copper foil was subjected to a heat treatment at 350° C. for 3 minutes, whereby a current collector of electrode 15 was obtained. As seen from the normal direction of the surface of the current collector, a ratio (A1/(A1+A2)) of the total area A1 of the bumps to a sum of the total area A1 of the bumps and the total area A2 of the dents was 19%.

<Formation of Active Material Layer>

With a method and conditions similar to those for electrode 12, active material layers each including a plurality of pillar-like active material members (number of layers: 7 layers) were formed on both faces of the current collector obtained with the above method, whereby electrode 15 was obtained.

The thicknesses of the active material layers formed on the front face and the rear face of the current collector of electrode 15 were both 20 μm. The amount of oxygen contained in the resultant active material layer was quantified by combustion method, which indicated that the composition of the compound containing silicon and oxygen was SiO_{0.6}. Moreover, electrode 15 had a tensile strength of 8.0 N/mm, and its tensile strength per 1 μm of active material layer thickness was found to be 0.40 N/mm.

(i-16) Electrode 16

### <Production of Current Collector>

By using the roughened copper foil used for electrode 15, a current collector was formed through a roll treatment, with a method similar to the method described above with reference to FIGS. 14(a) and (b). However, instead of the ceramic roller 280, a carbide roll having dents 281 formed thereon by laser engraving was used. Each dent 281 had a diamond shape as seen from the normal direction of the surface of the carbide roller. The lengths of a diagonal a′ and a diagonal b′ of each diamond shape were 12 μm and 20 μm. Adjoining dents 281 had an interval e′ of 18 μm along the diagonal a′ and an interval d′ of 26 μm along the diagonal b′. Each dent 281 had a depth of 10 μm.

Next, with a line pressure of 1.0 t/cm, the above roughened copper foil was passed between the aforementioned carbide roller and another roller (not shown) which was placed so as to oppose it, thus performing a roll treatment. As a result, a plurality of bumps having shapes corresponding to the aforementioned dents 281 were formed on the roughened copper foil, while the regions of the roughened copper foil where no bumps were formed became dents. Thus, a current collector of electrode 16 was obtained.

Each bump formed by the above method had a height of 6 μm, and the upper face of each bump had a diamond shape whose diagonal a was 11 μm and whose diagonal b was 19 μm. The arraying pitch Pₐ along the diagonal a was 29 μm, and the arraying pitch P_{b} along the diagonal b was 46 μm. Furthermore, as seen from the normal direction of the current collector surface, a ratio (A1/(A1+A2)) of the total area A1 of the bumps to a sum of the total area A1 of the bumps and the total area A2 of the dents was 17%.

<Formation of Active Material Layer>

On the surface of the current collector obtained with the above method, an active material layer was formed by using the vapor deposition apparatus 40 shown in FIG. 3. First, the current collector was placed on the stage 43 of the vacuum chamber 41. The stage 43 was tilted with respect to the horizontal plane 50 so that the evaporation angle ω was)65° (ω=65°). In this state, while supplying oxygen gas to the vacuum chamber 41, silicon was evaporated from the evaporation source, thus forming silicon oxide on each bump of the current collector surface. The acceleration voltage of an electron beam with which the evaporation source was irradiated was −8 kV, with the emission being set to 260 mA. The oxygen flow rate was 30 sccm, and the vapor deposition time was 1 minute. Thus, first portions of the active material members were formed (first vapor deposition step).

Next, the stage 43 was rotated clockwise around its center axis, and was tilted in a direction opposite to the tilting direction of the stage 43 in the aforementioned first vapor deposition step, such that the evaporation angle ω was −65°, thus forming second portions of the active material members (second vapor deposition step).

Thereafter, up to seventh portions of the active material members were formed while alternately switching the evaporation angle ω between 65° and −65°.

Then, with the oxygen flow rate being 0, eighth to thirty-fifth portions of the active material members were formed while alternately switching the evaporation angle ω between 65° and −65°. As a result, an active material layer including pillar-like active material members each composed of 35 layers was formed. Note that the vapor deposition times in the first to thirty-fifth vapor deposition steps were all 1 minute.

Next, the current collector was removed from the stage 43, and was again placed on the stage 43 so that the opposite face (rear face) from the front face on which the active material layer had been formed faced upward. With a method similar to the above, vapor deposition steps were performed for the rear face of the current collector, thus forming an active material layer composed of 35 layers. In this manner, electrode 16 having active material layers formed on both faces was obtained.

The thicknesses of the active material layers formed on the front face and the rear face of the current collector of electrode 16 were both 14 μm. The amount of oxygen contained in the resultant active material layer was quantified by combustion method, which indicated that the composition of the compound containing silicon and oxygen was SiO_{0.3}. Moreover, electrode 16 had a tensile strength of 10.1 N/mm, and its tensile strength per 1 μm of active material layer thickness was found to be 0.72 N/mm.

(i-C2) Electrode C2

In electrode C2, as a current collector, a roughened copper foil obtained by roughening both faces of an electrolytic copper foil having a thickness of 18 μm via electrolytic plating (thickness 27 μm; Ra=1.5 μm; Furukawa Circuit Foil Co., Ltd.) was used.

Formation of the active material layer was performed by using the vapor deposition apparatus 40 shown in FIG. 3. First, the current collector was placed on the stage 43, and the stage 43 was fixed horizontally so that its angle with respect to the horizontal plane 50 was 0°. Thus, the angle (evaporation angle ω) between the evaporation direction of silicon atoms and the normal direction D of the current collector was 0°.

In this state, while supplying oxygen gas to the vacuum chamber 41, silicon was evaporated from the evaporation source, thus forming an active material layer of silicon oxide on each bump of the current collector surface. The acceleration voltage of an electron beam with which the evaporation source was irradiated was −8 kV, with the emission being set to 260 mA. The oxygen flow rate was 20 sccm.

Next, the current collector was removed from the stage 43, and was again placed on the stage 43 so that the opposite face (rear face) from the front face on which the active material layer had been formed faced upward. With a method similar to the above, vapor deposition steps were performed for the rear face of the current collector, thus forming an active material layer. In this manner, electrode C2 having active material layers formed on both faces was obtained.

The thicknesses of the active material layers formed on the front face and the rear face of the current collector of electrode C2 were both 12 μm. The amount of oxygen contained in the resultant active material layer was quantified by combustion method, which indicated that the composition of the compound containing silicon and oxygen was SiO_{0.6}. It had a tensile strength of 5.4 N/mm, and its tensile strength per 1 μm of active material layer thickness was determined to be 0.45 N/mm.

(i-C3) Electrode C3

Electrode C3 was produced by using a method and conditions similar to those for electrode 12, except that the current collector was subjected to 1 hour of heat treatment in an inert ambient at a temperature of 600° C. before forming the active material layer, and that active material members (number of layers: 7) were formed by alternately switching the evaporation angle ω between 55° and −55°.

The thicknesses of the active material layers formed on the front face and the rear face of the current collector of electrode C3 were both 20 μm. The composition of the compound contained in the resultant active material layers was SiO_{0.6}. Moreover, electrode C3 had a tensile strength of 5.4 N/mm, and its tensile strength per 1 μm of active material layer thickness found to be 0.27 N/mm.

(ii) Measurement of Linear Voidage

Next, the linear voidages of Example electrodes 12 to 16 and Comparative Example electrodes C2 and C3 were measured. The measurement method was similar to the method described above with reference to FIG. 10. The measurement results are shown in Table 2.

(iii) Measurement of Elongation Rate of Electrode C3

With a method similar to the above-described Examples (electrodes 1 to 11), the elongation rate of electrode C3 was measured to be 9.6%. The minimum linear voidage of electrode C3 was 6.6%, which is similar to the minimum linear voidage of e.g. electrode 11 shown in Table 1, but the elongation rate of electrode C3 was twice as large as the elongation rate (4.8%) of electrode 11. This is presumably because deformation of the electrode occurred due to expansion stress of the active material, since the tensile strength of the current collector per 1 μm of active material layer thickness was as small as 0.27 N/mm in electrode C3. It was confirmed from this result that not only is it necessary to provide sufficient voids in the active material layer, but the tensile strength of the current collector per 1 μm of active material layer thickness also needs to be controlled in order to suppress deformation of the electrode.

(iv) Evaluation of Electrode Deformation in Sample Batteries

Sample batteries were produced whose respective negative electrodes were Example electrodes 12 to 16 and Comparative Example electrodes C2 and C3, and were subjected to a constant current charge-discharge test. The methods and results thereof will be described.

<Production of Sample Battery>

First, 10 g of lithium cobaltate (LiCoO₂) powder having an average particle size of 10 μm as a positive-electrode active material, 0.3 g of acetylene black as a conductive agent, 0.8 g of polyvinylidene fluoride powder as a binder agent, and an appropriate amount of N-methyl-2-pyrrolidone (NMP) were mixed well, thereby preparing a paste of positive electrode mixture.

Next, the resultant paste of positive electrode mixture was applied onto one face of a positive-electrode current collector composed of an aluminum foil having a thickness of 20 μm. Thereafter, the paste of positive electrode mixture was dried and rolled, thus forming a positive-electrode active material layer. The positive electrode sheet obtained in this manner was cut into a predetermined shape, whereby a positive electrode was obtained. The thickness of the positive-electrode active material layer carried on one face of the current collector was 70 μm, with a size of 14.5 mm×14.5 mm. A positive electrode lead of aluminum was connected to the face of the current collector on which the positive-electrode active material layer was not present.

On the other hand, each electrode of the above Examples and Comparative Examples was shaped so that its electrode size was 15 mm by 15 mm, thus producing a negative electrode for a battery. Thereafter, the negative electrode for a battery was placed so as to oppose the aforementioned positive electrode via a separator, whereby an electrode group was obtained. As the separator, a porous film of polyethylene having a thickness of 16 μm (manufactured by Asahi Kasei Chemicals Corporation) was used. This electrode group was inserted in an outer case made of an aluminum laminate sheet, and after an electrolyte solution was further injected, the Al laminate was sealed. As the electrolyte solution, a nonaqueous electrolyte solution was used which was obtained by dissolving LiPF₆ at a concentration of 1.2 mol/L in a solvent in which ethylene carbonate (EC) and ethyl methyl carbonate (EMC) were mixed at a volume ratio of 1:1. Thus, battery samples were obtained.

<Constant-Current Charging and Discharging of Sample Electrodes and Evaluations>

Next, constant-current charging of these battery samples was carried out. In the constant-current charging, the end voltage was 4.2 V, and the current value was 0.5 mA/cm². The charge capacity of each battery was about 6 mAh/cm², regardless of the sample.

Each battery sample having experienced constant-current charging and discharging was disassembled, and presence or absence of wrinkles and deformation was confirmed by observing the negative electrode for a battery.

The results of observation are shown in Table 2 together with the constructions of the respective electrodes and the measurement results of linear voidage. The “thickness of active material layer” described in Table 2 refers to an average thickness between the respective active material layers formed on the front face and the rear face of the current collector. As mentioned earlier, in these Examples and Comparative Examples, the active material layers formed on the front face and the rear face are equal in thickness.

Moreover, the surface states of electrode C2, electrode C3, and electrode 13 after constant-current charging and discharging of the sample batteries are shown in FIGS. 15(a) to (c), respectively.

TABLE 2

| | electrode | electrode | electrode | electrode | electrode | electrode | electrode |
|---|---|---|---|---|---|---|---|
| | 12 | 13 | 14 | 15 | 16 | C2 | C3 |
| Base thickness of | 18 | 18 | 18 | 24 | 24 | 18 | 18 |
| current collector | | | | | | | |
| [μm] | | | | | | | |
| protrusion height | 5 | 5 | 5 | 6 | 6 | — | 5 |
| [μm] | | | | | | | |
| area ratio of bump | 23 | 23 | 23 | 19 | 17 | no bumps | 23 |
| regions | | | | | | | |
| A1/(A1 + A2) [%] | | | | | | | |
| number of times n | 7 | 7 | 5 | 7 | 35 | — | 7 |
| of evaporation | | | | | | | |
| thickness of | 20 | 20 | 20 | 20 | 14 | 12 | 20 |
| active material | | | | | | | |
| layer [μm] | | | | | | | |
| Average value of | 0.6 | 0.6 | 0.6 | 0.6 | 0.3 | 0.6 | 0.6 |
| molar ratio x of | | | | | | | |
| oxygen amount | | | | | | | |
| relative to | | | | | | | |
| silicon amount | | | | | | | |
| tensile strength | 14.0 | 10.4 | 10.4 | 8.0 | 10.1 | 5.4 | 5.4 |
| [N/mm] | | | | | | | |
| Tensile strength | 0.70 | 0.52 | 0.52 | 0.40 | 0.72 | 0.45 | 0.27 |
| of current | | | | | | | |
| collector per 1 μm | | | | | | | |
| of thickness of | | | | | | | |
| active material | | | | | | | |
| layer [N/mm] | | | | | | | |
| Minimum linear | 8.2 | 8.2 | 8.1 | 8.1 | 12 | — | 6.6 |
| voidage [%] | | | | | | | |
| Wrinkles of | NO | NO | NO | NO | NO | YES | YES |
| electrode plate | | | | | | | |
| elongation rate | | | | | | | 9.6 |
| [%] | | | | | | | |

As can be seen from FIG. 15(a) and Table 2, in electrode C2, the electrode plate was greatly deformed due to charging and discharging although it had a sufficient tensile strength of the current collector per 1 μm of active material layer thickness. This is presumably because the active material layer of electrode C2 is a so-called unpatterned film, so that spaces for alleviating the expansion stress of the active material were not obtained in the active material layers.

Moreover, as can be seen from FIG. 15(b) and Table 2, electrode C3 did not deform as much as electrode C2 due to charging and discharging, although a current collector having a substantially similar tensile strength to that of electrode C2 was used. This is presumably because the active material layer of electrode C3 included a plurality of active material members, so that spaces for alleviating active material stress exited between adjoining active materials. However, wrinkles were also observed in electrode C3, across substantially the entire electrode plate surface. This is presumably because, although the linear voidage of the active material layers of electrode C3 was 5% or more, the tensile strength of the current collector per 1 μm of active material layer thickness was small, i.e., less than 0.3 N/mm, so that expansion stress in the active material members acted on the current collector to cause wrinkles.

On the other hand, as can be seen from FIG. 15(c), electrode plate deformation such as wrinkles was not observed in electrode 13. Although not shown, wrinkles were not observed in electrodes 12, 14 to 16, either. Presumably, the linear voidage of the active material layers was sufficiently large in these electrodes, so that expansion stress of the active material due to charging and discharging was alleviated, thus suppressing electrode deformation such as wrinkles. It is also presumable that the sufficiently large tensile strength of the current collector per 1 μm of active material layer thickness helped to more effectively suppress electrode deformation due to expansion stress.

It was found from the results shown in Table 1 and Table 2 that it is possible to suppress deformation of the electrode due to charging and discharging by controlling the linear voidage of the active material layers and also sufficiently increasing the tensile strength of the current collector per 1 μm of active material layer thickness, regardless of the production method and thickness of the current collector, the method of forming the active material layers and the number of layers, and the like.

### INDUSTRIAL APPLICABILITY

A negative electrode for a lithium secondary battery according to the present invention is applicable to various lithium secondary batteries, e.g., coin-type, cylindrical-type, flat-type, or prismatic-type. Such lithium secondary batteries can be broadly used in PCs, mobile phones, mobile information terminals such as PDAs, audio-visual devices such as videorecorders and memory audio players, and the like, because of having better charge-discharge cycle characteristics than conventionally while ensuring a high charge-discharge capacity.

1. An electrode for a lithium secondary battery, comprising:
a current collector having a plurality of bumps on a surface thereof; and
an active material layer including an active material member formed on each of the plurality of bumps, wherein,
the plurality of bumps are regularly arrayed at an interval from one another on the surface of the current collector;
a growth direction of the active material members is tilted with respect to a normal direction of the current collector;
voids are formed between adjoining active material members;
a proportion which the voids account for in the active material layer along any arbitrary direction is 5% or more on a plane which is parallel to the surface of the current collector; and
tensile strength of the current collector per 1 μm of height of the active material members is no less than 0.3 N/mm and no more than 1 N/mm.

2. The electrode for a lithium secondary battery of claim 1, wherein the tensile strength of the current collector per 1 μm of height of the active material members is no less than 0.6 N/mm and no more than 1 N/mm.

3. The electrode for a lithium secondary battery of claim 1, wherein the proportion of the voids is 8% or more.

4. The electrode for a lithium secondary battery of claim 1, wherein the plurality of bumps are arrayed along a predetermined direction, and a ratio of the interval between adjoining bumps to a distance between centers of the adjoining bumps along the predetermined direction is no less than ⅓ and no more than ⅔.

5. The electrode for a lithium secondary battery of claim 1, wherein, as seen from the normal direction of the current collector, a ratio of a total area of the plurality of bumps to an area of the surface of the current collector is no less than 10% and no more than 30%.

6. The electrode for a lithium secondary battery of claim 1, wherein the plurality of bumps have a height of no less than 4 μm and no more than 15 μm.

7. The electrode for a lithium secondary battery of claim 1, wherein an angle between the growth direction of the active material members and the normal direction of the current collector is no less than 5° and no more than 70°.

8. The electrode for a lithium secondary battery of claim 1, wherein each of the active material members has a plurality of portions with different growth directions.

9. The electrode for a lithium secondary battery of claim 8, wherein each of the active material members has a plurality of layers stacked on the surface of the current collector, and growth directions of the plurality of layers are tilted in alternately opposite directions with respect to the normal direction of the current collector.

10. The electrode for a lithium secondary battery of claim 9, wherein the number of the plurality of layers is no less than 2 and no more than 100.

11. The electrode for a lithium secondary battery of claim 1, wherein a proportion which the voids account for in the active material layer along a direction defining a closest distance between adjoining active material members is 30% or less.

12. The electrode for a lithium secondary battery of claim 1, wherein a volumetric ratio which the voids account for in the active material layer is 10% or more 70% or less.

13. The electrode for a lithium secondary battery of claim 1, wherein a capacity per unit area of the active material layer is no less than 2 mAh/cm² and no more than 8 mAh/cm².

14. The electrode for a lithium secondary battery of claim 1, wherein the current collector has a tensile strength of 6 N/mm or more.

15. The electrode for a lithium secondary battery of claim 1, wherein the current collector contains a copper alloy.

16. The electrode for a lithium secondary battery of claim 1, wherein the active material members contain silicon.

17. The electrode for a lithium secondary battery of claim 16, wherein the active material members contain silicon oxide, and an average value of a molar ratio of an oxygen amount relative to a silicon amount in the active material members is greater than 0.1 and less than 1.0.

18. A lithium secondary battery comprising:
the electrode for a lithium secondary battery of claim 1;
a counter electrode placed so as to oppose the electrode for a lithium secondary battery, the counter electrode being capable of occluding and releasing lithium ions;
a separator disposed between the counter electrode and the electrode for a lithium secondary battery; and
an electrolyte having lithium-ion conductivity.

19. A lithium secondary battery comprising: an electrode for a lithium secondary battery, a counter electrode placed so as to oppose the electrode for a lithium secondary battery, the counter electrode being capable of occluding and releasing lithium ions, a separator disposed between the counter electrode and the electrode for a lithium secondary battery, and an electrolyte having lithium-ion conductivity,
wherein the electrode for a lithium secondary battery includes
a current collector having a plurality of bumps on a surface thereof,
an active material layer including an active material member formed on each of the plurality of bumps;
the plurality of bumps are regularly arrayed at an interval from one another on the surface of the current collector;
a growth direction of the active material members is tilted with respect to a normal direction of the current collector;
voids are formed between adjoining active material members;
tensile strength of the current collector per 1 μm of height of the active material members is no less than 0.3 N/mm and no more than 1 N/mm; and
after charging and discharging are performed, a proportion which the voids account for in the active material layer along any arbitrary direction is 6% or more on a plane which is parallel to the surface of the current collector.
